(19) United States
(12) Patent Application Publication
(10) Pub. No.: US 2023/0372815 A1
(43) Pub. Date: Nov. 23, 2023

(54) GAME SYSTEM, GAME PROCESSING METHOD, AND GAME PROGRAM

(71) Applicant: GREE, INC., Tokyo (JP)

(72) Inventors: Shota SHIMODA, Tokyo (JP); Masatoshi TAKAYAMA, Tokyo (JP); Fumiya AMANO, Tokyo (JP)

(73) Assignee: GREE, INC., Tokyo (JP)

(21) Appl. No.: 18/129,611

(22) Filed: Mar. 31, 2023

(30) Foreign Application Priority Data
May 20, 2022 (JP) 2022-082897
Jan. 20, 2023 (JP) 2023-007305

(51) Int. Cl. A63F 13/48; A63F 13/44; A63F 13/533; A63F 13/79

(52) U.S. Cl. CPC A63F 13/48; A63F 13/44; A63F 13/533; A63F 13/79

(57) ABSTRACT

A game system includes (i) a memory that stores a user parameter related to a user of a game in association with user identification information that identifies the user, and (ii) one or more processors. The one or more processors (i) count an elapsed time since a first auto mode was started, and (ii) in the first auto mode, perform the game part of the game without input from the user until the elapsed time reaches a maximum running time that is determined based on the user parameter.

This application claims the benefit of priority from Japanese Patent Application No. 2022-082897 filed on May 20, 2022 and Japanese Patent Application No. 2023-007305 filed on Jan. 20, 2023, the entire contents of the prior applications being incorporated herein by reference.

### TECHNICAL FIELD

The disclosure of this specification relates to a game system, a game processing method, and a game program. The disclosure of this specification more specifically relates to a game system, a game processing method, and a game program that provides a game with an auto (i.e., automatic) mode for running a game part without any input from a user.

### BACKGROUND TECHNOLOGY

A game with an auto mode that runs a game part without any input from a user is known. In the auto mode, the game part advances without any input from the user. Thus, by running the game part in the auto mode, the user can acquire rewards such as experience points, game items, or the like at the end of that game part without executing any input. As such, the auto mode is a convenient feature for a user to acquire rewards efficiently.

### SUMMARY

### Problems to be Solved

When a game part in a manual mode, no calculations (for example, calculations to cause characters to play against each other and decide victory or defeat) are performed to advance the game part until input from a user is provided. In contrast, in an auto mode, no input from the user is required to advance the game part, so the calculations to advance the game part are constantly performed. For this reason, if the auto mode is made available without limitation, many computing resources will be required to advance the game part in the auto mode. To avoid excessive consumption of computing resources, it is desirable to appropriately restrict the use of the auto mode by the user.

In the related game, the game part is started by having the user spend game points. A game that requires a user to spend game points to start or continue the game part is sometimes called a “stamina-based” game. In a stamina-based game, game points are recovered to a maximum value along with the passage of time or by using game items. Therefore, in a stamina-based game, the game part does not start until the user game points have recovered to a value required to start the game part, so even if the auto mode is adopted, consumption of computing resources for performing calculations to advance the game part is suppressed. In contrast, a game that does not require the consumption of game points to start or advance a game part does not suppress the consumption of computing resources by game points. Thus, it is more desirable to introduce a mechanism for restricting the use of auto mode.

An object of this disclosure is to provide technical improvements that solve or alleviate at least some of the problems in the related technology discussed above. One of the more specific objects of this disclosure is to provide improvements in a game system, a game processing method, and a game program for providing a game with an auto mode. One of the more specific objects of this disclosure is to suppress the consumption of computing resources for providing a game with an auto mode.

Objects other than those described above of the disclosure of this specification will become apparent by reference to the entire specification. The embodiments disclosed in this specification may solve problems understood from descriptions of the embodiments, in lieu of or in addition to the above-described problems.

### Means of Solving Problems

One aspect relates to a game system comprising (i) a storage that stores a user parameter related to a user of a game in association with user identification information that identifies the user of the game, and (ii) one or a plurality of processors. In one aspect, the one or plurality of processors count an elapsed time since a first auto mode was started, and in the first auto mode, a game part of the game is run without input from the user until the elapsed time since the first auto mode was started reaches a maximum running time determined based on the user parameter.

Another aspect relates to a game system provided with one or more processors. In one aspect, in a first auto mode, one or more processors run a game part of a game without input from a user until an elapsed time from a start of the first auto mode reaches a maximum running time. In one aspect, the one or more processors (i) determine a first processing cycle required to run the game part for one cycle in the first auto mode, based on a first play time spent to advance the game part for one cycle in a manual mode, and (ii) in a first auto mode, run the game part for a maximum number of cycles that is determined based on the maximum running time and the first processing cycle.

### Effects

According to an embodiment, the consumption of computing resources for providing a game with an auto mode can be suppressed.

### BRIEF DESCRIPTION OF DRAWINGS

FIG. 1 is a block diagram showing a game system according to an embodiment.

FIG. 2 is a diagram schematically explaining game parts included in a game provided by game system of FIG. 1.

FIG. 3 is a diagram explaining user management data stored in the game system of FIG. 1.

FIG. 4 is a diagram explaining game media management data stored in the game system of FIG. 1.

FIG. 5 is a diagram explaining mode management data stored in the game system of FIG. 1.

FIG. 6 is a diagram explaining status data stored in the game system of FIG. 1.

FIG. 7 is a diagram explaining transitions between game modes included in the game provided by the game system of FIG. 1.

FIG. 8 is a diagram showing an example of a play screen displayed on a user device 10.

FIG. 9 is a schematic diagram for explaining mode switching using a switching button.

FIG. 10 is a schematic diagram for explaining a setting screen for explaining individual skill settings.

FIG. 11 is a schematic diagram for explaining a results screen.

FIG. 12 is a schematic diagram for explaining a status screen.

FIG. 13 is a flowchart explaining a flow of processing of game parts in a manual mode.

FIG. 14 is a flowchart explaining a flow of processing of game parts in a second auto mode.

FIG. 15 is a flowchart explaining a flow of processing of game parts in a first auto mode.

### EXEMPLARY EMBODIMENTS

Various embodiments will be described below with reference to the drawings as appropriate. The same reference numbers are used throughout the drawings for structural elements that are common to multiple drawings. The embodiments described below do not limit the scope of claims. The structural elements described in the following embodiments are not necessarily essential to the problem solving means.

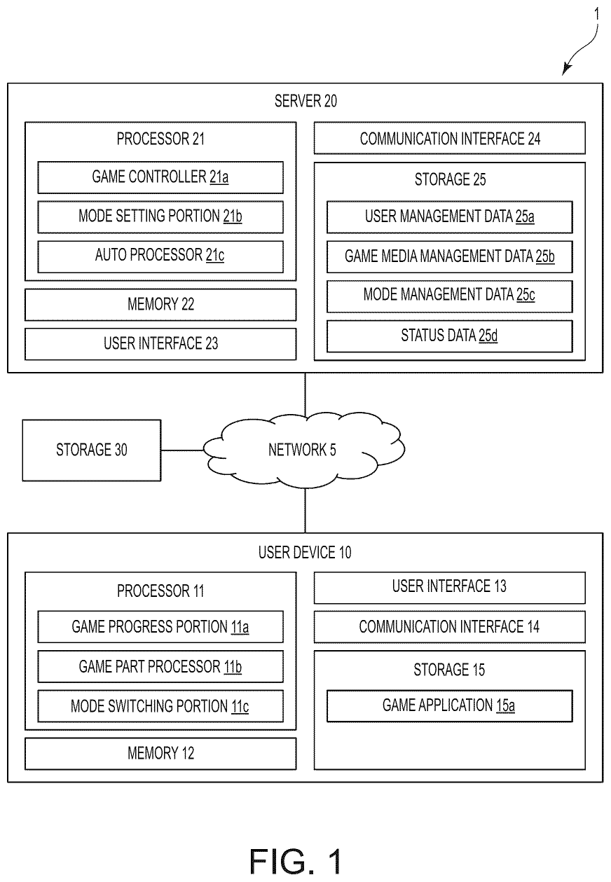

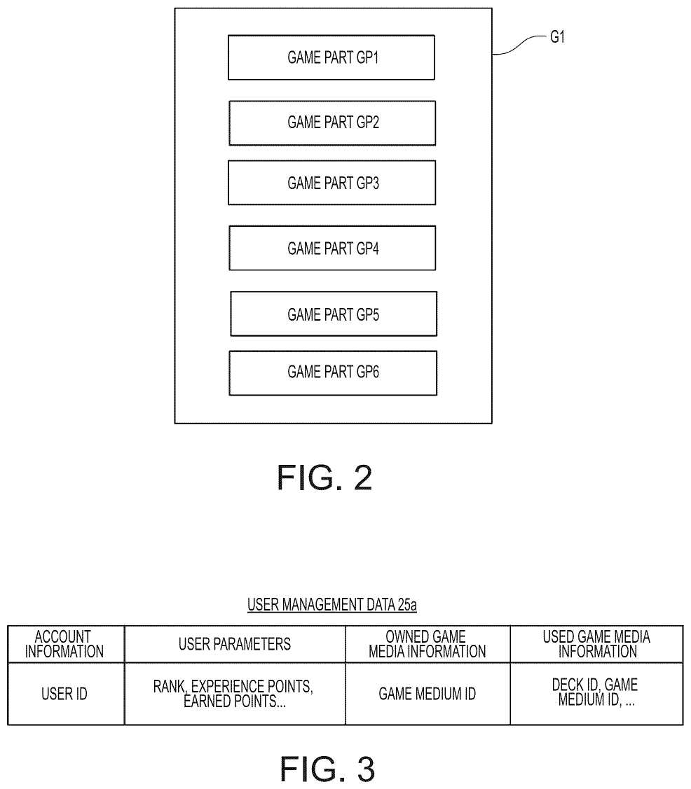

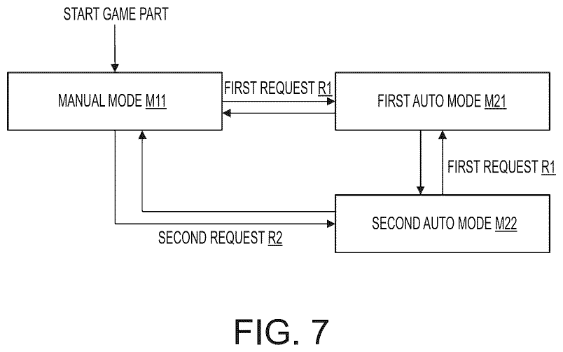

A game system 1 of an embodiment will be described with reference to FIGS. 1-7. The game system 1 is an example of a system to which the features disclosed in this specification can be applied. FIG. 1 is a block diagram showing the game system 1 according to an embodiment. FIG. 2 is a diagram schematically explaining game parts included in a game provided by the game system 1. FIGS. 3-6 are diagrams respectively explaining information stored in the game system of FIG. 1. FIG. 7 is a diagram explaining transitions between game modes included in the game provided by the game system 1.

As shown in FIG. 1, the game system 1 is provided with a user device 10 and a server 20. The game system 1 may be provided with a storage (memory) 30. The user device 10, the server 20, and the storage 30 are communicably connected to each other via a network 5. The network 5 may be a single network or may be constituted by multiple networks connected together. The network 5 is, for example, the Internet, a mobile communications network, or a combination thereof. Any network that enables communication between electronic devices can be applied as the network 5.

The user device 10 realizes various functions related to the game by executing a command set included in a game application 15a. The server 20 provides various services related to the game to the user device 10. The user device 10 and the server 20 cooperate with each other as necessary to realize various functions of the game.

The game provided by the game system 1 includes a plurality of game parts as shown in FIG. 2. In the example shown in FIG. 2, game G1 provided by the game system 1 includes six game parts from game parts GP1 to GP6. The number of game parts may also be less than six or more than six.

The game parts are content that a user can play within the game. The game parts are, for example, quests, missions, mini games, events, content that constitutes part of the game other than these, or combinations thereof. The game parts may have game tasks set that the user should clear. If the tasks set in the game parts are achieved, a reward may be given to the user. The accomplishment of the tasks set in the game parts is sometimes called clearing the game parts. By clearing a game part, a reward corresponding to that cleared game part may be given to the user. Clearing each game part completes one cycle of that game part. As will be described below, the game parts may be run repeatedly over multiple cycles, either automatically or upon user selection.

The game parts of an embodiment may be battle game parts. In the battle game parts, a task may be set to play and win against an enemy character. In the battle game parts, a user uses his/her own character and plays against the enemy character. The enemy character may be a non-player character NPC or a character of another player. Winning and losing in the battle game parts are determined according to a predetermined game logic. In the battle game parts, the user can compose a deck containing a plurality of game media (for example, characters) and play against the enemy characters using the game media in the deck. In the battle game parts, the user character that plays against an enemy character is sometimes called a user character. Although not depicted in the drawings, for each battle game part, information about the enemy characters appearing in that battle game part may be stored in the server 20. For example, in association with a game part ID that identifies the game part, (i) an enemy character ID that identifies each one or a plurality of enemy characters that appear in the game part, (ii) parameters indicating the capabilities (for example, offensive and defensive power, and the like) of each of the one or plurality of enemy characters, and (iii) other information necessary to run the battle game part can be stored.

The game parts may be single-play or multiple-play game parts. The single-play game parts are played by one user. The multiple-play game parts are played by two users or more.

In an embodiment, a user may select any game part from among a plurality of game parts and advance the game part that has been selected. For example, in the embodiment shown in FIG. 2, a user may select any game part from among the game parts GP1-GP6. Some game parts may be set so that they cannot be selected by the user until other game parts have been cleared. For example, the game part GP3 may be set to not accept a selection from the user until the game part GP1 is cleared. A structure may be provided in which the plurality of game parts included in game G1 branch along a scenario.

At least some of the plurality of game parts included in the game may be repeatedly run by the user. For example, after the user clears the game part GP1, s/he may select the game part GP1 again. The user can repeatedly play the same game part so as to repeatedly acquire rewards that can be acquired by clearing the game part. The reward given to the user by clearing the game part may be the same each time. If the user clears the same game part multiple times, a different reward may be given each time s/he clears it.

The game may be a “stamina-based” game, which requires the consumption of game points to start the game part, or a “non-stamina-based” game, which does not require the consumption of game points to start or advance the game part. An example of a stamina-based game is known. In the stamina-based game, game points are reduced when the game part is started or advanced and are recovered to a maximum value along with the passage of time or by using game items. In the stamina-based game, in order to start the game part, the user must wait until game points are recovered or use game items. In the “non-stamina-based” game, the user can start the game part at any time without being restricted by a decrease in game points, if there is no other restriction.

Playing the same game part repeatedly can be tedious for the user. The game system 1 provides an auto mode that clears the game part without input from the user. By using the auto mode, the user can acquire a reward that is given when the game part is cleared even if the input to operate the game is not performed in the user device 10. In this specification, a game mode that does not require input from the user to clear the game part is called an “auto mode,” and a game mode that requires input from a user to advance or clear the game part is called a “manual mode.” That is, once the game part is moved to the auto mode, the game part is cleared without any further input from a user after that. In the auto mode, input from a user may be allowed, and processing may be performed according to the input from the user. In the auto mode, even when input from the user is allowed, the input from the user is not required to clear the game part; thus, user input time is reduced. Details of the auto mode will be described hereafter.

Referring again to FIG. 1, the user device 10 and the server 20 will be further explained.

The user device 10 is a smartphone, a personal computer (PC), a mobile phone, a tablet terminal, an electronic book reader, a wearable computer, a game console, a head mounted display, or any of a variety of information processing devices other than these. The user device 10 is intended to be used by a user(s) playing a game(s). The user can input to the user device 10 and play the game through images and sounds output from the user device 10.

The user device 10 is provided with a processor 11, a memory 12, a user interface 13, a communication interface 14, and a storage 15.

The processor 11 is a calculator that loads an operating system and various other programs from the storage 15 or other storage into the memory 12 and executes commands included in the loaded programs. The processor 11 can be, for example, a CPU, an MPU, a DSP, a GPU, any of a variety of calculators other than these, or combinations thereof. The processor 11 may be realized by an integrated circuit such as an ASIC, a PLD, an FPGA, or an MCU.

The memory 12 is used to store commands executed by the processor 11 and various data other than these. The memory 12 is a main memory device (main memory) that can be accessed by the processor 11 at high speed. The memory 12 is constituted by RAM such as DRAM and SRAM.

The user interface 13 is provided with (i) an input interface that accepts an input from a user and (ii) an output interface that outputs a variety of information under control of a processor 21. The input interface is a keyboard, a pointing device such as a mouse, a touch panel, or any information input device that can input user input other than the above. The output interface is, for example, a liquid crystal display, an organic Electro-Luminescence (EL) display, a display panel, or any information output device other than the above that can output calculation results of the processor 11.

The communication interface 14 is implemented as hardware, firmware, communication software such as a TCP/IP driver or a PPP driver, or a combination thereof. The user device 10 can send and receive data to and from other information devices, including the server 20, via the communication interface 14.

The storage 15 is an external memory device accessed by the processor 11. The storage 15 is, for example, a magnetic disk, an optical disk, a semiconductor memory, or any memory device other than the above that can store data.

The server 20 is provided with the processor 21, a memory 22, a user interface 23, a communication interface 24, and a storage 25. The above descriptions of the processor 11, the memory 12, the user interface 13, the communication interface 14, and the storage 15 also apply to the processor 21, the memory 22, the user interface 23, the communication interface 24, and the storage 25. Thus, detailed descriptions of the processor 21, the memory 22, the user interface 23, the communication interface 24, and the storage 25 are omitted.

Next, information that is stored in the storages 15 and 25 will be explained.

A game application 15a for providing various functions of a game is stored in the storage 15. Commands included in the game application 15a can be executed by the processor 11. Details of the functions that are realized by running the game application 15a will be described hereafter. The game application 15a may be downloaded to the user device 10 from, for example, an application distribution platform not depicted.

The user device 10 can, as needed, acquire data required to advance the game part from the server 20 and store the acquired data in the storage 15. The data that is used or referenced so as to advance the game part may be stored in the storage 15 or 25.

User management data 25a, game media management data 25b, mode management data 25c, status data 25d, and data other than these that are required to provide a game are stored in the storage 25. At least some of the user management data 25a, the game media management data 25b, the mode management data 25c, and the status data 25d are referenced by the user device 10 as needed. At least some of the user management data 25a, the game media management data 25b, the mode management data 25c, and the status data 25d may be stored in the user device 10 as needed.

Referring to FIG. 3, the user management data 25a will be explained. The user management data 25a is a data set in which various data related to a user who plays the game provided by the game system 1 are structurally stored. In the user management data 25a, account information of the user, various parameters set for the user, owned game media information related to game media owned by the user, used game media information related to used game media used by the user in the game, and various other data related to the user may be included.

The account information is, for example, a user ID that identifies the user. A user name can be included in the account information. In the game system 1, a user can be uniquely identified by the user ID. The user name shows a title of the user used in the game.

Parameters of the user may include the user's rank, experience points, earned points, and other user parameters associated with the user that change as the user plays the game. The rank of the user is a parameter showing a skill level of the user regarding the game. The rank may increase as the user plays the game. A parameter stored in the user management data 25a is an example of a user parameter used to define a maximum running time that shows an upper limit of duration of a first auto mode M21, which will be described hereafter.

The owned game media information of the user is information related to game media owned by the user in the game. The game media is electronic data used in the game. The game media may include, for example, characters, cards, items, points, in-service currency (or in-game currency), tokens (for example, Non-Fungible Token (NFT)), tickets, avatars, parameters, and other electronic data used in the game. The game media may be acquired, owned, used, managed, exchanged, combined, enhanced, sold, discarded, or gifted or the like by the user in the game. The owned game media information may include a game medium ID that identifies a game medium owned by the user in the game. If the game medium is acquired by the user, the game medium ID that specifies the game medium is stored as owned game media information in association with the user ID of the user. Hereinafter, unless otherwise indicated, game media “owned” by a user indicates game media associated with the user ID of the user. Additionally, to “give” game media to a user means to associate the game media with the user ID of the user as game media “owned” by the user. Furthermore, to “discard” game media owned by a user means to dissolve the association between the user ID of the user and the game media. Also, to “consume” game media owned by a user means to generate an effect in a game according to the disassociation of the user ID from the owned game media. Additionally, to “sell” game media owned by a user indicates that (i) the user ID of the user is disassociated from the game media and (ii) the user ID is associated with other game media (for example, virtual currency or an item or the like) as owned game media. Furthermore, to “assign” game media owned by user A to user B means that (i) the user ID of the user is disassociated from the game media and (ii) the user ID of user B is associated with the game media. Also, to “create” game media indicates defining or determining at least part of the information related to the game media.

Used game media information is information showing game media used by a user in a game part (for example, battle game part). A game medium used by the user in a battle game part is selected from among owned game media. The game medium used by the user in the battle game part may be selected according to a user-operated selection, or automatically selected from among the used game media. If the used game media is selected in order to run the battle game part, a deck may be constituted by the used game media. In this case, a deck ID that identifies a deck including the game medium selected as used game media may be included in the used game media information.

Various information about the user other than the above may be included in the user management data 25a. If the game system 1 provides a stamina-based game, the user management data 25a may include stamina of the user. Stamina is a parameter that is consumed when the game part is started or advanced. Stamina consumption may be set for each game part. Stamina recovers to the maximum value along with the passage of time. It can also be recovered by using an item(s).

Friend information may be included in the user management data 25a. Friend information related to a user shows a user ID of a user(s) who is in a friend relationship with the user. For example, if user A is in a friend relationship with users B and C, friend information related to user A includes user IDs of users B and C. Users in a friend relationship cooperate with each other so as to be able to play the game.

Some of data stored in the user management data 25a is updated as needed as the game advances. For example, the rank of the user increases as the user plays the game. Some of data stored in the user management data 25a is not updated as the game advances. For example, user IDs remain unchanged as the game advances.

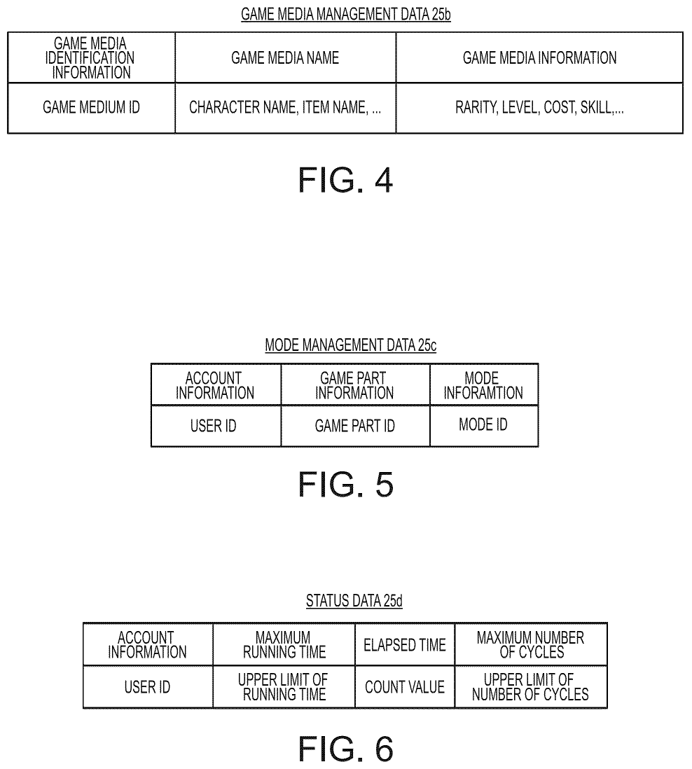

Referring to FIG. 4, the game media management data 25b will be explained. The game media management data 25b is a data set in which various data related to game media used in a game provided by the game system 1 is structurally stored. In the game media management data 25b, game media identification information of various game media, game media names, game media information showing features of game media, and various data related to game media other than these may be included.

A game medium ID is an ID that identifies a game medium. The game medium name shows a name of the game medium.

Various information showing the features of the game media is included in the game media information. For example, rarity, level, cost, life, attack power, defense power, and game function information are included in the game media information. Rarity is information showing scarcity (scarcity value) of a game medium. That is, rarity associated with a game medium shows the difficulty in acquiring the game medium. The level shows growth of the game medium. For example, the higher the level value, the higher the growth of the game medium. In this embodiment, the level value may increase as the user plays the game. The cost is a parameter that is used when a deck used for a battle game part is determined. For example, a deck is set with an upper limit for a total cost of game media that can be included in the deck. The user may select a game medium (or media) included in the deck so that the total cost does not exceed the upper limit.

The life is a parameter that is used to determine victory or defeat of a user in a battle game part. In the battle game part, the life decreases when a character of the user is attacked by an enemy character. The life may be recovered to the upper limit or lower by using a recovery item(s). When lives of all characters included in the deck of the user become zero, it may be determined that the user has been defeated in the battle game part.

Attack power of a game medium is a parameter that contributes to the amount of damage inflicted on the enemy character by the attack of the game media. The greater the value of attack power, the greater the amount of damage inflicted on the enemy character. The defense power of a game medium is a parameter that contributes to the amount of damage that the game medium receives from an attack received from an enemy character. The greater the value of defense power, the lesser the amount of damage received from an enemy character's attack.

The game media information may include game function information. The game function information associated with the game media shows game functions for game media to generate game effects in the game part. In the technical field, the game functions are sometimes called skills or abilities. In some games, “spells” used by characters also correspond to game functions. When a game function is used in a game part, the game effect associated with that game function is generated. Game effects generated by the use of game functions in a battle game part include increased attack power, increased defense power, life recovery, and other effects that affect the outcome of a game against an enemy character.

In the game functions, there may be included (i) a limited game function that has a limitation on its use in a predetermined sub-mode in a second auto mode (for example, a limited mode in the second auto mode that will be explained below) and (ii) a non-limited game function that does not have a limitation on its use in the predetermined sub-mode in the second auto mode. The limited game function may be a game function that has a limitation or a condition placed on its use in the game. The limited game function may include (i) a game function with a limited number of uses (that is, there is an upper limit on the number of uses), (ii) a game function that requires the consumption of points or parameters in order to use the game function, or (iii) a game function that belongs to a predetermined category (for example, a recovery skill, a buffing skills, a debuffing skill, a special move, and other categories not mentioned above). The number of times the limited game function is used can be recovered to the maximum limit along with the passage of time, by the use of an item(s), or by a method other than these. Points or parameters consumed in order to use the limited game function can be recovered to the maximum limit along with the passage of time, by the use of an item(s), or by a method other than these.

Hereinafter, for the purpose of explaining the game functions, “skills” are mainly mentioned, but the description of “skills” applies to other game functions (for example, abilities) as well.

Referring to FIG. 5, the mode management data 25c will be explained. A game part included in the game provided by the game system 1 can be played in one of a plurality of game modes. The mode management data 25c is a data set to manage which game part is being played by each user in one of the plurality of game modes. Game modes set for the game parts of the game provided by the game system 1 may include a manual mode M11, a first auto mode M21, and a second auto mode M22. The mode management data 25c may include (i) account information of a user, (ii) game part information related to a game part being played by the user and (iii) mode information related to a current game mode of the game part. The game part information is a game part ID that identifies the game part. The mode information is a mode ID for identifying the game mode.

Referring to FIG. 7, the game modes of the game parts included in the game provided by the game system 1 will be explained. In an embodiment, the game modes that are set for the game parts of the game provided by the game system 1 include (i) the manual mode M11 that requires input of the user to clear the game parts and (ii) auto modes that do not require input of the user to clear the game parts. The first auto mode M21 and the second auto mode M22 are included in the auto modes.

Assuming that the user has selected the running of a battle game part, the manual mode M11, the first auto mode M21, and the second auto mode M22 that are set for this battle game part will be explained.

When the battle game part starts, the game mode may be set to the manual mode M11. When the battle game part is run in the manual mode M11, the user inputs an instruction for a user character via the user interface 13 of the user device 10. In the instructions for the user character, attacking an enemy character, using skills and items, and other instructions are included. The user may perform input other than instructions to non-user characters. If the battle game part is turn-based, the instructions from the user are input during an attack turn of the user. The user character takes action according to the input from the user. For example, the user character attacks an enemy character according to the input from the user to instruct an attack on the enemy character. In an attack turn of the enemy character, the user character is attacked by the enemy character. The life of the enemy character may be decreased by attacks from the user character, and the life of the user character may be decreased by attacks from the enemy character. In the battle game part, victory and defeat are determined according to a predetermined game logic. For example, if the life of the enemy character has decreased to zero, it is determined that the user has lost. Processing in the manual mode of the battle game part is not limited to those specified in this specification. Various algorithms are known that run a battle game part in a manual mode. The game system 1 may use any known game mechanics to process game parts in the manual mode as long as it does not create inconsistencies.

Each game part may be run as one cycle from the start to the end of one battle. The game parts may be repeatedly run in units of one cycle. In the battle game part, for example, one cycle is run from the start of the battle to the determination of the result of victory or defeat. In the manual mode M11, the battle game part may be repeatedly run according to a selection of the user. In the manual mode M11, the battle game part may be repeatedly run even if there is no user request.

Thus, in the manual mode M11, even after the battle game part has started, input from the user is required to proceed with the battle against the enemy character and clear the battle game part. If an input required from the user is not made in the battle game part that is set in the manual mode M11, the game part does not advance until the required input is received from the user. For example, the game part does not advance until there is an instruction from the user in the attack turn of the user character, and remains in the attack turn until there is input from the user. In the manual mode M11, if a modal is shown, the game part may not advance until there is a response from the user with respect to the modal.

In the first auto mode M21, after the battle game part has started, a battle between the user character and the enemy character is run without input from the user. The first auto mode M21 is continuously run for a maximum running time. That is, the maximum running time is the upper limit of the time that the first auto mode M21 can continue after the mode is transitioned to the first auto mode M21. In the first auto mode M21, a game part is run over a plurality of cycles in units of one cycle. In the first auto mode M21, when each cycle ends, victory and defeat in the battle may be determined. In the first auto mode M21, when each cycle ends, a reward(s) may be determined that is given to the user. In the first auto mode M21, the time elapsed after the first auto mode M21 is started is counted, and when the elapsed time reaches the maximum running time, the first auto mode M21 ends. When the first auto mode M21 ends, a reward(s) may be determined that is given to the user. When the first auto mode M21 is ended by an instruction(s) of the user before the maximum running time has elapsed, a reward(s) may be determined that is given to the user based on the number of completed cycles that have been completed up to that end point.

When the game part is run in the first auto mode M21, an auto processing cycle may be set that shows the time required to run the game part in one cycle. When the auto processing cycle is set for the first auto mode M21, a quotient of the maximum running time divided by the auto processing cycle is a maximum value of number of cycles that can be run in the first auto mode M21 within the maximum running time. In this specification, the upper limit of the number of cycles run in the first auto mode M21 is sometimes called the maximum number of cycles. In the first auto mode M21, the game part can be repeatedly run for the maximum number of cycles if there is no instruction by the user to interrupt. In the first auto mode M21, the determination of victory or defeat in each cycle may be made collectively for a plurality of cycles run during an elapsed time after the predetermined time has elapsed since the first auto mode M21 was started. For example, the determination of victory or defeat in each cycle may be made collectively when the first auto mode M21 ends. To reduce a computing load, in the first auto mode M21, it may be determined that the user wins in all cycles.

A process to advance the game part in the first auto mode M21 may be performed in the user device 10. The user device 10 may perform a first advance process to advance the first auto mode M21 while the game application 15a is running in the foreground. The first advance process to advance the first auto mode M21 may be a simpler process than a second advance process to advance the second auto mode M22, which will be described hereafter. For example, in the first auto mode M21, the user device 10 may not execute a battle process (for example, generating a game animation(s) showing damage calculations, life calculations, and battle processing) according to a battle logic, but may calculate the number of completed cycles, which shows how many cycles the game part has been processed since the first auto mode M21 started, and perform a process that displays this number of completed cycles on the display. In the first auto mode M21, a number of victories may be calculated showing the number of cycles the user is determined to have won since the first auto mode M21 started. If it is determined that the user wins in all cycles, the number of victories is equal to the number of cycles completed. Additionally, when the first auto mode M21 ends, the process of the first auto mode M21 may include determining a reward(s) to give to the user. The number of completed cycles can be calculated by a simple calculation based on (i) the time that has elapsed since the first auto mode M21 started and (ii) the auto processing cycle. Furthermore, the process for determining a reward(s) to be given to the user can also be performed with fewer computing resources than the process based on the battle logic.

In the user device 10, while the game application 15a is running in the background, a process for calculating the number of completed cycles is not run. However, when the game application 15 returns from the background to the foreground, the user device 10 can (i) calculate the number of completed cycles based on the time elapsed since the start of the first auto mode M21 at the time of the return, and (ii) display a status screen including the calculated number of completed cycles on a display. Therefore, looking at the status screen that was displayed when the game application 15a returned to the foreground, the user feels as if the first auto mode M21 was continuing to advance even while the game application 15a was running in the background. In the user device 10, when the game application 15a is ended after the first auto mode M21 is started, even if the game application 15a is reactivated, the number of completed cycles at the time of reactivation may be calculated, and the status screen including the calculated number of completed cycles may be displayed on the display. Looking at this status screen, the user feels as if the first auto mode M21 was continuing to advance even while the game application 15a is not being activated. As such, in the first auto mode M21, immediately after the game application 15a returns from the background to the foreground, or immediately after the game application 15a is reactivated after the game application 15a is ended, a status screen is displayed that includes a latest status of the process in the first auto mode M21. Thus, from the perspective of the user playing the game part in the first auto mode M21, while the game application 15a is running in the background, or even while the game application 15a is not being activated, the first auto mode M21 has the game part running uninterrupted.

For the user running the game part in the first auto mode M21, the status data 25d for managing progress of the game part(s) in the first auto mode M21 may be stored in the storage 25. Referring to FIG. 6, the status data 25d will be explained. The status data 25d is a data set in which various data for managing the status of the first auto mode M21 is structurally stored for each user running the game part in the first auto mode M21. In the status data 25d, in association with account information of the user, there are stored (i) the maximum running time of the first auto mode M21, (ii) the time elapsed since the first auto mode M21 started, and (iii) a maximum number of cycles that shows the upper limit of the number of cycles that can be run within the maximum running time in the first auto mode M21.

When a user runs a game part in the first auto mode M21, the maximum running time is determined based on a user parameter(s) of the user. A user parameter(s) of the user may be specified by referring to the user management data 25a. A user parameter to specify the maximum running time for a user may be, for example, rank of the user that is stored in the user management data 25a. In one aspect, the maximum running time may be calculated such that the higher the rank, the longer the maximum running time. The maximum time when a user is running a game part in the first auto mode M21 may be determined based on a user parameter other than the rank of the user.

The process for running a game part in the first auto mode M21 may be run in the server 20. Thus, when the game part is set in the first auto mode M21, even if the game application 15a is running in the background on the user device 10, the game part may be advanced in the server 20. Additionally, when the game part is set in the first auto mode M21, even if the game application 15a is not being activated in the user device 10, the game part may be advanced.

In the second auto mode M22 as well, as with the first auto mode M21, after the game part is started, a battle with an enemy character takes place without input from the user. When the game part is set in the second auto mode M22, the game part can be advanced only if the game application 15a is being run in the foreground on the user device 10. In other words, if the game part is set in the second auto mode M22, while an application other than the game application 15a is running in the foreground (while the game application 15a is running in the background), the process to advance the game part is interrupted. The interrupted game part may be resumed in response to the game application 15a being returned to the foreground. When the process of one cycle of the game part ends in the second auto mode M22, the process of the following cycle of the game part may be automatically started. After the process of one cycle of the game part ends in the second auto mode M22, the process of the following cycle of the game part may be started according to input from the user.

The second auto mode M22 is a game mode different from the first auto mode M21. As described above, in the first auto mode M21, the battle process (for example, generating a game animation(s) showing damage calculations, life calculations, and battle processing) according to the battle logic is not run, and a more simplified process is run. An example of the simplified process is to calculate the number of completed cycles based on the time elapsed since the first auto mode M21 was started, and display the calculated number of completed cycles. Thus, comparing the first auto mode M21 to the second auto mode M22, they differ in that the processing load to run the first auto mode M21 is smaller than the processing load to run the second auto mode M22. In one aspect, the second auto mode M22 may run the game part only when the game application 15a is running in the foreground. In the second auto mode M22, if the game application 15a is running in the background or if the game application is ended, the running of the game part is interrupted, which differs from the first auto mode M21 in which, on the contrary, the running of the game part is not interrupted even when the game application 15a is running in the background or when the game application is not running on the user device 10. Further differences between the first auto mode M21 and the second auto mode M22 will be described hereafter.

As shown in FIG. 7, the game part may be started in the manual mode M11. If a first request R1 is made by the user while the game part is running, the game part may be changed from the manual mode M11 to the first auto mode M21. On the contrary, if a predetermined transition condition is satisfied, the game part can be changed from the first auto mode M21 to the manual mode M11. If a second request R2 is made by the user while the game part is running, the game part may transition from the manual mode M11 to the second auto mode M22. If the first request R1 is made while the game part is being played in the second auto mode M22, the game part may transition from the second auto mode M22 to the first auto mode M21. On the contrary, if a predetermined transition condition is satisfied, the game part can transition from the first auto mode M21 to the second auto mode M22. Additionally, the game part can transition from the second auto mode M22 to the manual mode M11.

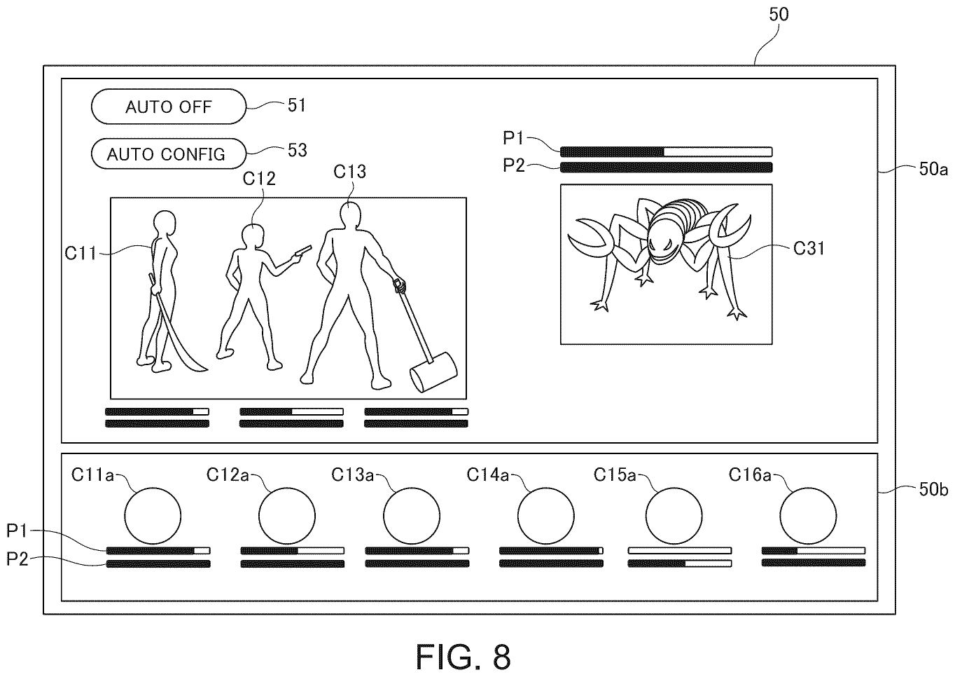

Next, referring additionally to FIGS. 8-12, functions of the user device 10 and the server 20 will be explained. FIGS. 8-12 show a screen or part of the screen shown in the user device 10 according to progress of the game part.

The processor 11 of the user device 10 functions as a game progress portion 11a, a game part processor 11b, and a mode switching portion 11c by executing a command set included in the game application 15a, or another command set.

The processor 21 of the server 20 functions as a game controller 21a, a mode setting portion 21b, and an auto processor 21c by executing a command set included in a program stored in the storage 25, and another command set(s) as needed. The game controller 21a processes a request or notification from the user device 10 based on a predetermined game logic. Additionally, the game controller 21a can control the progress of the game by providing various game data for running the game to the user device 10.

The game progress portion 11a works with server 20 to advance the game according to the input from the user via the user interface 13 (for example, a touch panel) of the user device 10. Examples of operation inputs from the user are (i) an input that specifies the game part to be run, (ii) an input to specify movement of a user character within a virtual space, (iii) an input to specify the use of an item, (iv) an input to change a game setting, and (v) other various inputs related to the progress of the game. For example, the game progress portion 11a can (i) generate a request related to the progress of the game, based on an input from the user or a command of a game program while the game program is running, and (ii) send the generated request to the server 20. Additionally, the game progress portion 11a can receive, from the server 20, various game data related to the progress of the game and advance the game, based on the game data. The game progress portion 11a can display, on the user interface 13 (for example, a display), an image or a video corresponding to the progress of the game.

The game progress portion 11a may acquire, from among various data stored in the storage 25, data required to advance the game, and store the acquired data in the storage 15. The game progress portion 11a can read data from storage 15 as needed for game processing and perform calculations using the read data.

The game progress portion 11a can detect operations on a GUI (Graphic User Interface), for example, displaying the GUI to allow the user interface 13 to select the game part.

The game progress portion 11a can specify the game part(s) that can be run by the user and display the specified game part(s) on the user interface 13. The game progress portion 11a can specify a game part that has been selected by the user, according to the operation of the user.

The game part processor 11b can start the game part that has been specified by the game progress portion 11a. For example, when the user has selected the game part GP1, the game part GP1 is started. The following description assumes that GP1 has been selected by the user.

The game part processor 11b sends, to the server 20, a running request for the selected game part GP1. If the server 20 (for example, the game controller 21a) receives a running request from the user device 10, data that is used for running the battle game part GP1 can be sent to the user device 10. The game part processor 11b may store, in the storage 15, data required to run the game part GP1 that has been acquired from the server 20.

The following description assumes that the game part GP1 is a battle game part that has been started by the game part processor 11b. Additionally, in this battle game part, it is assumed that a battle is being carried out between a user character included in a deck and an enemy character.

In the battle game part, for example, in a turn-based game, a battle is carried out between a user character and an enemy character. After the game part GP1 is started, the game part processor 11b alternatively generates (i) a first turn in which the user character acts and (ii) a second turn in which the enemy character acts. In each of the user characters or in a deck, a first action point is set that increases along with the passage of time. When this first action point reaches a predetermined value, a first interval may start. Similarly, in an enemy character or a group of enemy characters as well, a second action point is set that increases along with the passage of time. When this second action point reaches a predetermined value, a second interval may start.

Referring to FIG. 8, an example of processing in the battle game part will be explained. FIG. 8 shows an example of a play screen 50 that is displayed in the user device 10 while the battle game part is running. The play screen 50 is divided into a first area 50a and a second area 50b. The first area 50a shows a virtual space and various objects arranged in this virtual space. In the example shown, in the first area 50a, (i) objects showing user characters C11, C12, and C13, and (ii) an object showing an enemy character C31 are included.

In the second area 50b, icon images C11a-C16a of characters included in a deck of the user are displayed. In the deck, six user characters are included. Three user characters selected from these six user characters are displayed in the first area 50a. A battle is carried out between the three user characters included in the first area 50a and the enemy character. According to an instruction(s) from the user, a user character that is included in the deck, but is not participating in the battle (that is, a character that is not included in the first area 50a from among the user characters displayed in the second area 50b) may be replaced with a user characters included in the first area 50a. The user characters included in the first area 50a may be automatically replaced without user selection when a predetermined condition is satisfied.

In each of the first area 50a and the second area 50b, a life of each character may be displayed in association with an object of each character, or an icon image of each character. In the embodiment shown in the figure, each character has two types of lives: a first life P1 and a second life P2. When each character is attacked, the first life P1 first decreases. If the character is attacked after the first life P1 decreases to zero, the second life P2 of the character decreases. In other words, until the first life P1 becomes zero, the second life P2 does not decrease. The first life P1 and the second life P2 that are shown in the figure are examples of lives that are set for each character. The lives used in the game system 1 are not limited to what is shown in the figure.

The game part processor 11b can start the game part in the manual mode M11. When the game part is running in the manual mode M11, in a first interval, an input of an instruction for a user character from the user is accepted. In the instructions for the user character, attacking an enemy character, using skills and items, and other instructions are included. For example, when the game part processor 11b detects an input to instruct the user character C11 to attack the enemy character C31 via a GUI, it causes the user character C11 to attack the enemy character C31. Specifically, based on (i) a parameter such as attack power set for the user character C11 and (ii) a parameter such as defense power set in the enemy character, the damage the enemy character C31 receives is calculated. The game part processor 11b subtracts the calculated damage from the life of the enemy character C31. Thereby, the attack from user character C11 decreases the life of the enemy character C31. According to the input from the user, the game part processor 11b can cause the user characters C11-C13 to use skills and items, and to perform other actions related to a battle in addition to attacking the enemy character C31. In the first interval, the game part processor 11b may (i) cause the respective user characters C11-C13 to perform actions based on input from the user or (ii) cause only some of user characters C11-C13 to perform actions based on the input from the user.

When the first interval ends and the program moves to a second interval, the game part processor 11b causes the enemy character C31 to perform actions according to the battle logic as defined for the battle game part. For example, the game part processor 11b causes the enemy character C31 to attack some or all of the user characters C11-C13. Specifically, based on a parameter such as attack power set for the enemy character C31 and a parameter such as defense power set for the user characters C11-C13, the damage received by the user characters C11-C13 is calculated. The game part processor 11b subtracts the calculated damage from the lives of the user characters C11-C13.

When the user characters C11-C13 or the enemy character C31 perform actions such as an attack, the game part processor 11b generates an animation corresponding to the action and causes the generated animation to be displayed on the display of the user device 10.

The game part processor 11b determines victory or defeat in the battle game part according to a predetermined game logic. For example, when the second life P2 of the enemy character C31 has decreased to zero, it is determined that the user has won. On the contrary, for example, when the second life P2 of each of the user characters C11-C13 has decreased to zero, it is determined that the user has lost. When the user characters are playing against a plurality of enemy characters, when the second life P2 has decreased to zero for all the plurality of enemy characters, it may be determined that the user has won.

When it is determined that either the user or the enemy character has won in the game part, the game part processor 11b can end the process of the first cycle of the game part. When the process of the first cycle of the game part ends, the game part processor 11b may subsequently start the second cycle of the game part. As such, the user may repeatedly play the same game part.

When the process of one cycle of the game part 1 has ended, the game part processor 11b can give a reward to the user. For example, when it is determined that the use has won in the battle game part, the game part processor 11b can give a reward to the user. Even when the user has lost, the game part processor 11b may give a reward to the user. The reward to be given when the user has lost may be less than the reward when the user has won. Rewards to be given to the user are, for example, items, experience points (or points to improve other abilities of user characters), in-game currency, utility tokens, and electronic data other than these that may be incentives to the user. The reward to be given to the user may be defined for each game part. When the game part runs over a plurality of cycles, the reward to be given to the user may be different for each cycle. The process of giving a reward to the user may be part of the process in the game part or may be an additional process separate from the process of the game part. The reward to be given to the user may be determined by the time required to clear the game part. For example, the shorter the time in which the game part is cleared, the higher may be the value of the reward given.

The game part processor 11b may give different rewards (i) when the game part is cleared in the manual mode M11 and (ii) when the game part is cleared in an auto mode (the first auto mode M21 or the second auto mode M22). According to the algorithm that determines the reward(s), for example, a first reward and a second reward are determined such that the first reward that is given when the game part is cleared in the manual mode M11 is to be of higher value than the second reward that is given when the game part is cleared in the auto mode. In an example, a first reward and a second reward are determined such that rarity of an item that is given as a first reward tends to be higher than that of an item that is given as a second reward. In another example, an experience point or a point that is given as a first reward may be more than an experience point or a point that is given as a second reward.

On the play screen 50 shown in FIG. 8, in the first area 50a, a switching button 51 is included that switches the game mode between the manual mode M11 and the second auto mode M22. When an operation on the switching button 51 via the GUI is detected, the mode switching portion 11c may switch, to the second auto mode M22, the game part that is being advanced in the manual mode M11. In the manual mode M11, within the switching button 51, a text “AUTO OFF” is displayed showing that the game part that is being played is set in the manual mode (in other words, the auto mode is turned off).

If the switching button 51 is selected by the user while the game part is being advanced in the manual mode M11, the mode switching portion 11c switches the game part from the manual mode M11 to the second auto mode M22. The mode switching portion 11c may send, to the server 20, a mode switching notification to notify of the mode switching. In the mode switching notification that is sent from the user device 10 to the server 20, there may be included (i) a user ID of the user that is playing the game part, (ii) a game part ID that specifies the game part that is being played, and (iii) a mode ID that identifies the mode after switching. When the mode setting portion 21b of the server 20 receives the mode switching notification, it updates the mode management data 25c based on data included in the mode switching notification. Thereby, the server 20 can manage, for each user, what game mode the game part is running in.

After the game part is switched to the second auto mode M22, the game part processor 11b advances the battle against the enemy without input from the user. Specifically, in the second auto mode M22, according to a predetermined battle logic, the game part processor 11b can determine actions (for example, attacking an opponent and using skills or items) of the user characters C11-C13 and the enemy character C31 without input from the user. The game part processor 11b can (i) calculate the damage to the respective user characters C11-C13 and the enemy character C31, based on actions of the user characters C11-C13 and the enemy character C31 that are performed without input from the user and (ii) determine victory or defeat using the same reference to determine victory or defeat as in the manual mode M11. That is, in the second auto mode M22, based on the actions of the user characters C11-C13 and the enemy character C31 that are determined without input from the user, the damage to the user characters C11-C13 and the enemy character C31 is calculated, and it is determined that the user has won when the second life P2 of the enemy character C31 has decreased to zero. On the contrary, when the second life P2 of each of the user characters C11-C13 has decreased to zero, it is determined that the user has lost.

In the second auto mode M22 as well, as in the manual mode M11, when the user characters C11 to C13 or the enemy character C31 perform an action such as an attack, the game part processor 11b may generate an animation corresponding to the action and display the generated animation on the display of the user device 10.

In the second auto mode M22, the game part may be caused to advance even if there is no input from the user; thus, the user may acquire a reward to be given when the game part is cleared even if there is no input after the game part is started. As such, in the second auto mode M22, the game part can be cleared without input from the user, but input from the user may be accepted. When input from the user is accepted in the second auto mode M22, the actions of the user characters C11-C13 may be determined according to the input.

To reflect strategy and tactics in actions of the user characters in the second auto mode M22, a sub-mode may be set in the second auto mode M22. For example, the second auto mode M22 may be set to one of (i) a limited mode that that prohibits the use of a limited game function that satisfies a predetermined condition from among a plurality of game functions, or (ii) a non-limited mode, which also allows the use of the limited game function. As already described, the limited game function may include (i) a game function with a limited number of uses (that is, an upper limit is set on the number of uses), (ii) a game function that requires the consumption of points or parameters to use, or (iii) a game function belonging to a predetermined category (for example, a recovery skill, a buffing skill, a debuffing skill, a special move, or other category not mentioned above). When switching the game part to the second auto mode M22, the user may select either the limited mode or non-limited mode. By selecting the limited mode, the user can advance the game part in the second auto mode M22 while saving a skill that has a limited number of uses. Thereby, when the user ends the process of the game part in the second auto mode M22 and returns to the manual mode M11, s/he can perform a battle using the skill saved in the second mode M22. On the other hand, skills generate effects that give the user an advantage in the game; thus, by advancing the game part in the non-limited mode, a possibility of winning a battle against the enemy character C31 can be increased. For this reason, selecting the non-limited mode allows the user to acquire rewards more efficiently.

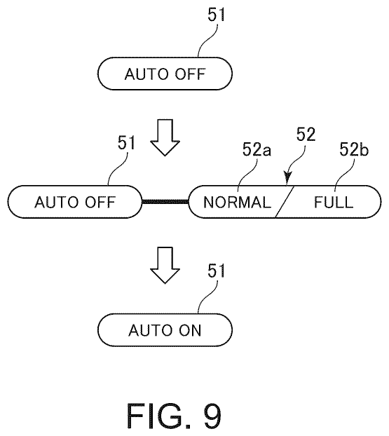

Referring further to FIG. 9, switching from the manual mode M11 to the second auto mode M22 will be further explained. As shown in FIG. 9, when the user selects the switching button 51 that displays “AUTO OFF” in the manual mode M11, the button progresses from the switching button 51 to a transition mode selecting button 52. The transition mode selecting button 52 is divided into (i) a first region 52a corresponding to the limited mode, and (ii) a second region 52b corresponding to the non-limited mode. After selecting the switching button 51 and progressing to the transition mode selecting button 52, the user can perform an instruction to transition to the second auto mode M22 in the limited mode by performing a touching operation on the first region 52a of the transition mode selecting button 52. Additionally, the user can perform an instruction to transition to the second auto mode M22 in the non-limited mode by performing a touching operation on the second region 52a of the transition mode selecting button 52.

If the transition to the second auto mode M22 in the limited mode is instructed, the game part processor 11b determines actions of the user characters C11-C13 under a limitation of not using skills with a limited number of uses. On the other hand, if the transition to the second auto mode M22 in the non-limited mode is instructed, the game part processor 11b determines actions of the user characters C11-C13 without eliminating the use of skills with a limited number of uses.

When the mode is switched to the second auto mode M22, the text displayed inside the switching button 51 displayed on the play screen 50 is changed to “AUTO ON” as shown in FIG. 9. For this reason, while the game part is being advanced in the second auto mode M22, “AUTO ON” displayed on the switching button 51 shows that the game part is running in the auto mode.

When the switching button 51 is selected by the user while the game part is being advanced in the second auto mode M22, the mode switching portion 11c switches the game part from the second auto mode M22 to the manual mode M11.

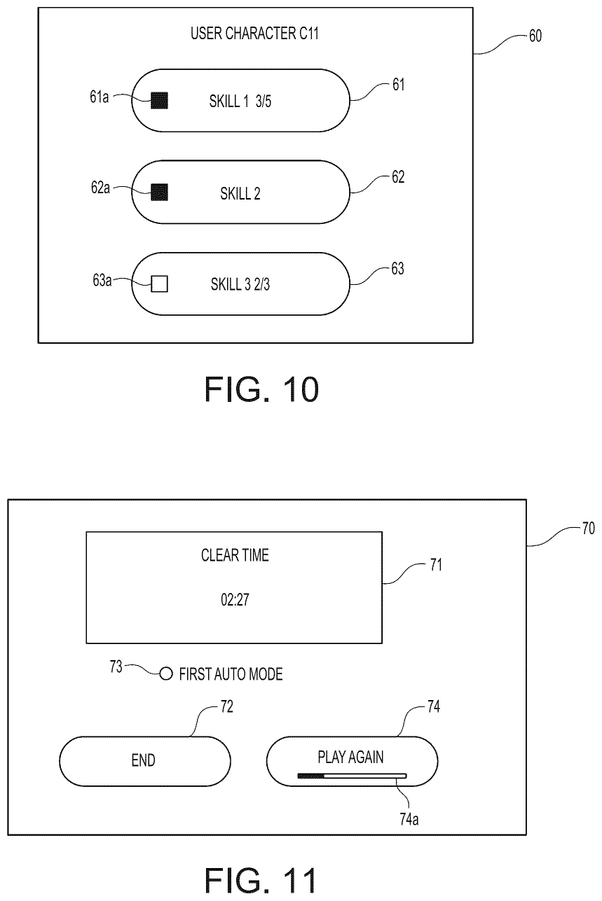

Whether skills with a limited number of uses are usable or not in the second auto mode M22 may be determined individually for each character and/or for each skill. A setting button 53 is included in the first area 50a of the play screen 50 shown in FIG. 8. If the game part processor 11b detects an operation on the setting button 53 via the GUI, a setting screen to set availability of skills for each user character is displayed on the display of the user device 10. FIG. 10 is an example of a setting screen 60 to set availability of each of a plurality of skills (skills 1-3) that are usable by the user character C11.

The setting screen 60 includes display elements 61-63. The display element 61 is a display element to set whether skill 1 is usable. In the display element 61, in addition to “skill 1,” an indication “⅗” is included. The denominator of “⅗” means that the maximum number of times skill 1 is usable is 5 times, and the numerator means that skill 1 is usable 3 times (the remaining skill is three times) when the setting screen is displayed. In this specification, the number of usable skills is sometimes called the number of remaining skills. The number of remaining skills can take an integer value between the upper limit of the skills used and zero. The display element 62 is a display element to set whether skill 2 is usable. Skill 2 has no usage limit, so the display element 62 does not include an indication of the number of uses. The display element 63 is a display element to set whether skill 3 is usable. The display elements 61-63 may include an explanation of effects that occur in the game when the corresponding skills 1-3 are used.

The display elements 61-63 include corresponding check boxes 61a-63a. When a checkbox is selected by the user, the skill corresponding to the selected check box is set to be usable in the second auto mode M22. For example, when the check box 61a is selected by the user, skill 1 is set to be usable in the second auto mode M22.

FIG. 10 is a setting screen for setting whether skills are usable in the second auto mode M22 for the user character C11. For other user characters as well, similar setting screens can be used to set, for each skill, whether the skill is usable in the second auto mode M22.

In an embodiment, even when the second auto mode M22 is set to the non-limited mode, skills that are set to be unusable by individual settings are not used in the second auto mode M22. For example, in the embodiment shown in FIG. 10, the skill 3 of the user character C11 is set to be unusable because the check box 63a is not checked. In this case, even if the second auto mode M22 is set to the non-limited mode, the game part processor 11b determines the actions of user character C11 so that the user character C11 does not use the skill 3.

In an embodiment, even when the second auto mode M22 is set to the limited mode, skills set to be usable by individual setting may be used in the second auto mode M22. For example, in an embodiment shown in FIG. 10, the check box 61a is checked; thus, skill 1 of the user character C11 is set to be usable. In this case, even if the second auto mode M22 is set in the limited mode, the game part processor 11b may cause the user character C11 to use skill 1.

Thus, individual settings of the skills for each user character using the setting screen 60 can take precedence over a sub-mode setting in the second auto mode M22 (setting of either the limited mode or the non-limited mode). Causing the individual setting to take precedence makes it easier to reflect user strategies and tactics in the actions of the user characters in the second auto mode M22.

In another embodiment, the sub-mode setting in the second auto mode M22 takes precedence over the individual setting of the skills for each user character using the setting screen 60. In this case, the sub-mode is set to the limited mode or the non-limited mode, and then whether the skills are usable can be individually set within an allowable range for the set sub-mode. For this reason, after easily setting the outline of the strategy or tactics for the second auto mode M22 by setting the sub-mode, the user may also use the setting screen 60 to individually set whether the skills are usable, thereby reflecting the strategy or tactics in the second auto mode M22 in more detail. For example, a user who would like to run the second auto mode M22 with a simpler operation may run the second auto mode M22 according to the sub-mode setting. On the other hand, by using the setting screen 60 to perform an individual setting for skills after setting the sub-mode, a user who would like to set in more detail whether the skills are usable can specify in more detail the strategy or tactics during a battle.

If the number of remaining skills is less than the upper limit for the number of times a skill may be used, the number of remaining skills may recover to the upper limit along with the passage of time. In addition to the passage of time, the number of remaining skills may be recovered to the upper limit for the number of times the skill may be used by (i) using items, (ii) clearing game parts, and (iii) the occurrence of events in the game other than these.

Next, referring to FIG. 11, switching to the first auto mode M21 will be explained. In an embodiment, switching to the first auto mode M21 is performed in response to the completion of one cycle of a game part in the manual mode M11 or the second auto mode M22.

FIG. 11 shows a result screen 70 that appears on the display of the user device 10 when one cycle of a game part has been completed in the manual mode M11 or the second auto mode M22. The result screen 70 includes a clear time display area 71, an end instruction button 72, a transition selection button 73 to select the transition to the first auto mode M21, and a replay button 74. Display of the result screen 70 and processing based on instructions via the result screen 70 are performed, for example, by the mode switching portion 11c.

The clear time display area 71 displays the play time spent to clear the game part cleared immediately before the result screen 70 is displayed in the manual mode M11 or the second auto mode M22. In the illustrated example, the clear time display area 71 displays “02:27.” This display indicates that it took 2 minutes and 27 seconds from the start to the end (clearance) of the game part cleared immediately before.

The end instruction button 72 is a button for ending the game part cleared immediately before. When the end instruction button 72 is selected, game part cleared immediately before ends without proceeding to the next cycle.

The transition selection button 73 is a button to select transition to the first auto mode M21. The transition selection button 73 is, for example, a radio button. When the user selects the transition selection button 73 via the GUI, the transition selection button 73 is placed in a selected state, and the selected state is maintained until the transition selection button 73 is selected again.

The replay button 74 is a button to select playing of the game part cleared immediately before again. If the replay button 74 is selected when the transition selection button 73 is not in the selected state (is in the non-selected state), the mode switching portion 11c resumes the game part that was cleared immediately before in the same mode as when it was cleared. For example, if the result screen 70 is displayed due to the game part being cleared in the manual mode M11, the game part is resumed in the manual mode M11 (the next cycle of the game part is started in the manual mode M11) by selecting the replay button 74 while the transition selection button 73 is in a non-selected state. If the result screen 70 is displayed due to the game part being cleared in the second auto mode M22, the game part is resumed in the second auto mode M22 (the next cycle of the game part is started in the second auto mode M22) by selecting the replay button 74 while the transition selection button 73 is in the non-selected state.

When the replay button 74 is selected while the transition selection button 73 is in the selected state, the mode switching portion 11c can switch the game part to the first auto mode M21. The mode switching portion 11c may send, to the server 20, a mode switching notification to notify that the game part has been switched to the first auto mode M21. The mode switching notification may include a user ID of the user playing the game part, a game part ID that identifies the game part, and a mode ID that identifies the mode after the switching. Upon receiving the mode switching notification, the mode setting portion 21b of the server 20 updates the mode management data 25c based on the data included in the mode switching notification. Thereby, the server 20 can manage which mode the game part is progressing in for each user.

The replay button 74 includes an indicator 74a that shows the elapsed time since the result screen 70 was displayed. The elapsed time since the result screen 70 was displayed, as indicated by this indicator 74a, reaches the upper limit of indicator 74a (the right end in the example shown in the figure) in a predetermined time (for example, 10 seconds). In this specification, the time from when the result screen 70 is displayed until the indicator 74a reaches the upper limit (that is, the time from when the result screen 70 is displayed until the replay button 74 is automatically selected) is sometimes called a “replay waiting time.” When the elapsed time since the result screen 70 was displayed reaches the upper limit of the indicator 74a (that is, when the replay waiting time has elapsed since the result screen 70 was displayed), it is determined that the replay button 74 has been selected, even if there has been no operation from the user.

When a mode switch notification showing that the game part has been switched to the first auto mode M21 is received at the server 20, the auto processor 21c runs the game part in the first auto mode M21. The game part in the first auto mode M21 is run without any input from the user. In auto processing in the first auto mode M21, the game part identified by the game part ID included in the mode switching notification is repeatedly run for multiple cycles. In the first auto mode M21, the repetition unit when repeatedly running a game part is called a “cycle.” For example, if a game part is run for 10 cycles, the game part is repeatedly run 10 times.

In order to run the game part in the first auto mode M21, the auto processor 21c calculates a maximum running time representing the upper limit of the time during which the game part is continuously run. The maximum running time is determined based on a user parameter associated with the user ID included in the mode switching notification. For example, the maximum running time is calculated based on at least one of the user parameters stored in the user management data 25a. The maximum running time is determined, for example, based on the “rank” among the user parameters. The maximum running time may be defined to be longer as the rank of the user is higher. A list that defines the correspondence between the rank and the maximum running time may be created in advance, and the auto processor 21c may refer to the list to determine the maximum running time. The maximum running time may be determined based on a user parameter other than rank (for example, experience points, earned points). User parameters used to define the maximum running time are not limited to those specified in this specification. The maximum running time is determined based on a parameter relating to the user's proficiency in the game or the user's playing time of the game. This makes it possible to set a long maximum running time for a user with a high level of game skill or a user with a long playing time. That is, a user with a high level of skill in the game or a user who has played for a long time can continuously use the first auto mode M21 for a long time. The maximum running time is set to, for example, 8 hours for the lowest ranking users. The maximum running time increases as the user's rank increases. The maximum value of the maximum running time that increases as the user's rank increases is set to, for example, 100 hours.

The auto processor 21c calculates the auto processing cycle required to run one cycle of the game part in the first auto mode M21, based on the play time spent to clear one cycle of the game part (hereinafter sometimes referred to as “clear time”) immediately before the transition to the first auto mode M21. The auto processing cycle may be calculated by a method of adding a predetermined time to the clear time taken to clear one cycle of the game part immediately before the transition to the first auto mode M21. This added time may be, for example, 10 seconds, 15 seconds, 20 seconds, 25 seconds, or 30 seconds, but is not limited to these. Assuming that the added time is 20 seconds, as shown in FIG. 11, if the clear time of the game part cleared immediately before is 2 minutes and 27 seconds, the auto processing cycle is calculated to be 2 minutes and 47 seconds by adding 20 seconds to 2 minutes and 27 seconds. The added time that is added to the clear time to calculate the auto processing cycle can be regarded as the waiting time before moving from the current cycle to the next cycle in the first auto mode M21. Therefore, in this specification, the added time that is added to the clear time to calculate the auto processing cycle is sometimes called an “interval between cycles.”

In an embodiment, the interval between cycles is longer than the replay waiting time. For example, if the replay waiting time is 10 seconds, the interval between cycles is longer than 10 seconds. By making the interval between cycles longer than the replay waiting time, the interval between cycles can be shorter in the second auto mode M22 than in the first auto mode M21, so the game part can be repeatedly run a greater number of times in the predetermined time in the second auto mode M22 than in the first auto mode M21. This allows the user who is trying to earn more rewards in auto mode to be guided to the second auto mode M22. Since the second auto mode M22 can be run when the game application 15a is running in the foreground of the user device 10, it is possible to increase the play time in the second auto mode M22. Thereby, the user's engagement with the game can be increased.

Different intervals may be used between the cycles (i) when the game part is cleared in the manual mode M11 immediately before the transition to the first auto mode M21 and (ii) when the game part is cleared in the second auto mode M22 immediately before the transition to the first auto mode M21. For example, the interval between cycles used when the game part is cleared in the manual mode M11 immediately before the transition to the first auto mode M21 can be made smaller than the interval between cycles used when the game part is cleared in the second auto mode M22 immediately before the transition to the first auto mode M21. As a result, the user can be guided to play in the manual mode M11 rather than in the second auto mode M22. By increasing the play time in the manual mode M11, the user's engagement with the game can be increased.

Based on the maximum running time and the auto processing cycle, the auto processor 21c can calculate a maximum number of cycles that indicates how many cycles the game part is repeatedly run in the first auto mode M21. The maximum number of cycles is calculated so that the smaller the auto processing cycle, the larger the maximum number of cycles. The auto processor 21c can set the maximum number of cycles as the quotient obtained by dividing the maximum running time by the auto processing cycle. For example, if the maximum running time in the first auto mode M21 is 8 hours and the auto processing cycle is 2 minutes and 47 seconds, the maximum number of cycles is 172 cycles. If the maximum running time is not divisible by the auto processing cycle, the remainder may be discarded. The method of calculating the maximum number of cycles used in the first auto mode M21 is not limited to the method described above.

Thus, if the game part is cleared in the manual mode M11 immediately before the transition to the first auto mode M21, the auto processing cycle (first processing cycle) is determined based on the clear time in the manual mode M11, and the maximum number of cycles is determined based on this first processing cycle and the maximum running time M21. If the game part is cleared in the second auto mode M22 immediately before the transition to the first auto mode M21, the auto processing cycle (second processing cycle) is determined based on the clear time in the second auto mode M22, and the maximum number of cycles is determined based on this second processing cycle and the maximum running time.

In the first auto mode M21, unlike in the second auto mode M22, actions (attacks and the like) of the user character and the enemy character may not be determined. In the first auto mode M21, one cycle of the game part may be advanced by a simpler method than the victory/defeat determination in the second auto mode M22. As described above, in the second auto mode M22, the damage to each of the user characters C11-C13 and the enemy character C31 can be calculated based on actions of the user characters C11-C13 and the enemy character C31 that are determined without input from the user, and based on this damage, the victory or defeat can be determined using the same reference used for the victory or defeat determination in the manual mode M11. On the other hand, in the first auto mode M21, the victory or defeat can be determined probabilistically based on parameters indicating each character's ability (for example, attack power and defense power) set for each character, without calculating each character's actions or the damage each character receives. Thus, in the first auto mode M21, the battle game part can be advanced for one cycle by determining the victory or defeat probabilistically based on the parameters indicating the abilities of each character that are set for each character, without calculating the actions of each character or the changes in parameters (for example, life) caused by those actions. Therefore, in the first auto mode M21, the victory or defeat in the game part can be determined with a smaller calculation load than in the second auto mode M22. In the first auto mode M21, unlike the second auto mode M22, it is not necessary for an animation representing a battle between the user character(s) and the enemy character to be generated. In the first auto mode M21, no processing needs to be performed to advance the game part, except for processing to determine the victory or defeat that is performed in the auto processing cycle. That is, no processing to advance the game part needs to be performed between the determination of the victory or defeat in one cycle and the determination in the next cycle. In the first auto mode M21, it is acceptable to perform processing for each auto processing cycle only when the game application 15a is running in the foreground. For example, in the first auto mode M21, when the game application 15a is running in the foreground, the number of completed cycles may be calculated based on (i) the elapsed time from the start of the first auto mode M21 and (ii) the auto processing cycle, and it may be determined whether this number of completed cycles has reached the maximum number of cycles. In the first auto mode M21, the victory or defeat may not be determined for each cycle. Since the first auto mode M21 is a mode for the user to efficiently earn rewards, it may be specified that the user always wins in each cycle. By specifying that the user always wins in each cycle, the processing for determining the victory or defeat becomes unnecessary, thereby reducing the processing load in the first auto mode M21. In the first auto mode M21, the victory or defeat in each cycle may be determined collectively after a predetermined time has elapsed since the first auto mode M21 started, for the multiple cycles run during that elapsed time. For example, the victory or defeat in each cycle may be determined collectively at the end of the first auto mode M21 (after the elapse of the maximum running time).

As described above, in an embodiment, the auto processor 21c can perform the process for determining the victory or defeat each time the auto processing cycle comes after the start of the first auto mode M21. The auto processor 21c performs a number of victory/defeat determinations equal to or less than the maximum number of cycles, in the period between the start and the end of the first auto mode M21. In another embodiment, the auto processor 21c can collectively perform a number of victory/defeat determinations equal to or less than the maximum number of cycles. In yet another embodiment, by specifying that the user always wins each cycle, the process of determining the victory/defeat in the auto processor 21c can be omitted.

The auto processor 21c can determine a reward to be given to the user after the first auto mode M21 ends (that is, after the maximum running time has elapsed). For example, the auto processor 21c can determine the reward to be given to the user based on the number of times the user is determined to have won from the start to the end of the first auto mode M21. In this case, the greater the number of times the user is determined to have won, the greater the reward that may be given to the user. In addition to or instead of the number of times the user is determined to have won from the start to the end of the first auto mode M21, the auto processor 21c may determine the reward to be given to the user based on the maximum number of cycles. If a reward is also given upon the user's defeat as well, the reward given to the user may be determined based on (i) the number of times the user is determined to have won from the start to the end of the first auto mode M21 in the first auto mode and (ii) the maximum number of cycles.

The auto processor 21c may determine the reward to be given to the user at the end of each processing cycle of the game part. The auto processor 21c may determine the reward to be given to the user in the same manner as in the manual mode M11. For example, if a battle game part is run in the first auto mode M21, the auto processor 21c may give a reward to the user when the user is determined to have won. The auto processor 21c may also give a reward to the user if the user is defeated. Thus, the greater the maximum number of cycles in the first auto mode M21, the greater the opportunity for a reward to be given to the user.

As described above, the reward given to the user in the first auto mode M21 is determined so that the greater the maximum number of cycles, the greater the reward. When the reward increases according to the number of times the user wins, the reward also increases as the maximum number of cycles increases because the possibility that the number of times the user wins also increases as the maximum number of cycles increases. Additionally, if a reward is given regardless of whether the user wins or loses, or if it is specified that the user wins in every cycle, the reward will increase according to the maximum number of cycles.

The reward given to the user in the first auto mode M21 may be determined based on the score obtained in the game part cleared immediately before the transition to the first auto mode M21, experience points, various points obtained by clearing game parts other than those mentioned above, or a combinations thereof (hereinafter simply referred to as “points earned”), in addition to or instead of the maximum number of cycles. A game part may be designed in such a way that the user needs to spend a longer time to clear the game part in order to earn more points by clearing that game part. For example, assume a game part in which multiple enemy characters appear in the game part and the game part is designed so that the player can clear the game part by defeating a target character among the multiple enemy characters. Furthermore, in the game part, it is assumed that points can be earned each time an enemy character is defeated, and in the first auto mode M21, the reward given to the user is calculated so that the shorter the clear time of the game part, the greater the reward is, and the more points the user has earned in the game part, the greater the reward is. In this case, in order to earn a greater reward in the first auto mode M21, the user, when playing the game part before transmission to the first auto mode M21, can adopt the strategy of defeating the target character first so as to clear the game part in a short time, or can adopt the strategy of defeating other enemy characters before the target character so as to increase the points earned in the game part. In this way, by specifying the reward given to the user in the first auto mode M21 based on the points earned in the game part cleared immediately before the transition to the first auto mode M21, the strategies that the user can adopt to increase the reward earned in the first auto mode M21 are diversified, thereby improving the strategic nature of the game.

The process for running the game part in the first auto mode M21 is run by the server 20 (for example, by the auto processor 21c). Therefore, the running of the game part in the first auto mode M21 is not interrupted even if the game application 15a is not being run in the foreground on the user device 10. In other words, the running of the game part in the first auto mode M21 is not interrupted even if the game application 15a is running in the background on the user device 10. Therefore, the user can run applications other than the game application 15a in the foreground on the user device 10 while the game part is being run in the first auto mode M21.

Further, even if the game application 15a is not being activated on the user device 10 or the power of the user device 10 is turned off, the game part is run without interruption in the first auto mode M21.

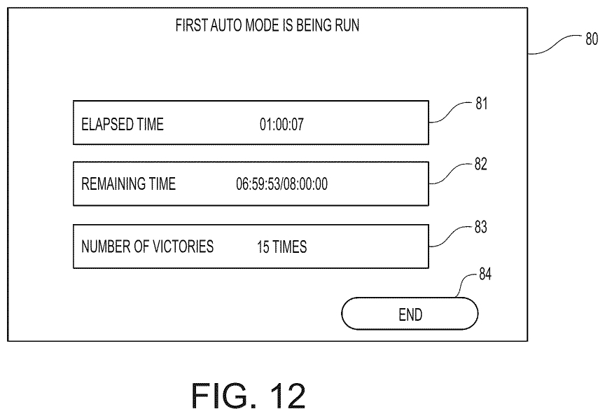

The user can check the status of the first auto mode M21 even before the first auto mode M21 ends (that is, before the maximum running time has elapsed since the start of the first auto mode M21). For example, when the game application 15a is running in the foreground on the user device 10, the game part processor 11b can display a status screen indicating the processing status in the first auto mode M21 on the display of the user device 10. FIG. 12 shows an example of a status screen 80 shown on the display of the user device 10.

The status screen 80 includes the text “First auto mode is running” indicating that the first auto mode M21 is running, display elements 81-83, and an end button 84. The display element 81 indicates the elapsed time since the first auto mode M21 was started. The display element 82 indicates the remaining time in the first auto mode M21. The remaining time of the first auto mode M21 is calculated by subtracting, from the maximum running time, the elapsed time from the start of the first auto mode M21. The display element 83 displays the number of times the user has been determined to have won from when the battle game part was started in the first auto mode M21 until the status screen 80 was displayed. In the embodiment shown in FIG. 12, if the auto processing cycle in the first auto mode M21 is 2 minutes and 47 seconds as described above, one cycle of the game part is completed every 2 minutes and 47 seconds from the start of the first auto mode M21. Therefore, processing of the game part has been completed for 21 cycles within 1 hour and 7 seconds from the start of the first auto mode M21. The display element 83 shows that the user has won 15 times out of the 21 cycles of the battle game part that have been completed since the start of the first auto mode M21. If it is specified that the user wins each cycle, the number of victories will be 21, equal to the number of cycles completed. In this case, the number of victories displayed on the display element 83 is 21 times. If it is specified that the user wins each cycle, the number of completed cycles may be displayed on the display element 83, representing the number of cycles completed since the start of the first auto mode M21 (“21 times” in the above example).

The status screen 80 may be displayed on the user device 10 in response to the game application 15a running in the background returning to the foreground. In an embodiment, the number of victories or the number of completed cycles displayed on the status screen 80 may be calculated in real time during running of the first auto mode M21. For example, the number of victories or the number of completed cycles may be incremented each time a period of time corresponding to the auto processing cycle elapses. In another embodiment, the number of victories or the number of completed cycles displayed on the status screen 80 may be calculated in response to transition of processing of the game application 15a from the background to the foreground. For example, the number of victories or the number of completed cycles may not be calculated while the processing of the game application 15a is running in the background, and the number of completed cycles and/or the number of victories may be calculated based on (i) the elapsed time from the start of the first auto mode M21 at the time of return to the foreground and (ii) the auto processing cycle, in response to the return of the game application 15a to the foreground. By not calculating the number of victories or the number of completed cycles while the processing of the game application 15a is running in the background, computing resources can be saved. If the number of victories or completed cycles is not calculated while the game application 15a is running in the background, other processing related to the game mode (for example, processing related to the battle such as calculating the amount of damage, determining the victory/defeat in each cycle, and generating animations corresponding to the character's actions) may not be run. Thus, by not performing processing to advance the game part when the processing of the game application 15a is running in the background, and by performing processing related to the running of the game part (for example, calculating the number of completed cycles, calculating the number of victories, and/or calculating the remaining time) when the processing of the game application 15a returns to the foreground, even if the processing of the game application 15a transitions to the background after the processing of the game part in the first auto mode M21 is started, the running of the game part in the first auto mode M21 can be continued until the elapse of the maximum running time. While the processing of the game application 15a is transitioned to the background, the processing related to the running of the game part is not performed, but even if no processing related to the running of the game part is performed while the game application 15a is running in the background, it will not interfere with the user playing the game part because the processing of calculating the number of completed cycles and the like is performed when the game application 15a returns to the foreground. More specifically, because processing related to the running of the game part (for example, calculation of the number of cycles completed) is performed in response to the processing of the game application 15a returning to the foreground, and the calculation results are displayed on the status screen 80, the user can check the status of the game part in the first auto mode M21 when the game application 15a returns to the foreground. Therefore, even if no processing related to the running of the game part is performed while the processing of the game application 15a is transitioned to the background, by displaying the status screen 80 upon returning to the foreground, the user is given the impression that the game part is continuing to advance even in the background.

The status screen 80 may be displayed on the user device 10 in response to the game application 15a being activated on the user device 10. In this case, the number of victories or the number of completed cycles displayed on the status screen 80 may be calculated in response to the game application 15a being activated. For example, the number of victories or the number of completed cycles is not calculated while the game application 15a is not activated, but in response to the game application 15a being activated, the number of completed cycles and/or the number of victories may be calculated based on (i) the elapsed time from the start of the first auto mode M21 at the time the game application 15a is activated and (ii) the auto processing cycle. Computing resources can be saved by not calculating the number of victories or the number of completed cycles while the game application 15a is not running. If the calculation of the number of victories or the number of completed cycles is not performed while the game application 15a is not running, other processing related to the game mode may also not be performed. Thus, by not performing processing to advance the game part when the game application 15a is not activated, and by performing processing (for example, calculation of the number of completed cycles, calculation of the number of victories, calculation of the remaining time) related to running of the game part when the game application 15a is activated, even if the game application 15a is ended on the user device 10 after the processing of the game part in the first auto mode M21 has started, the running of the game part in the first auto mode M21 can continue until the elapse of the maximum running time. Since the processing related to the running of the game part (for example, calculation of the number of cycles completed) is performed in response to the game application 15a being activated again after it was ended, and the calculation results are displayed on the status screen 80, the user can check the status of the game part in the first auto mode M21 at the time the game application 15a is activated. Thus, even if no processing related to the running of the game part is performed while the game application 15a is not activated, displaying the status screen 80 when the game application 15a is activated can give the impression to the user that the game part is continuing to advance even if the game application 15a is not activated.

The information used to calculate the number of completed cycles, that is, the elapsed time from the start of the first auto mode M21 and the auto processing cycle, may be stored in the user device 10, in the server 20, or in both the user device 10 and the server 20.

The status screen 80 may be displayed on the user device 10 as a notification from the game application 15a running in the background. The user may determine whether or not to return the game application 15a to the foreground based on the progress of the first auto mode M21 displayed on the status screen 80. For example, if the remaining time of the first auto mode M21 is running low on the status screen 80, the game application 15a may be returned to the foreground.

The trigger for the status screen 80 to be displayed is not limited to the above. For example, a display timing of the status screen 80 may be determined when the first auto mode M21 is run, and the status screen 80 may be displayed in response to the arrival of this determined display timing. In an embodiment, the timing for displaying the status screen 80 can be the timing of the completion of the game part for a predetermined number of cycles after the first auto mode M21 is started. For example, if the display timing of the status screen 80 is the timing at which the processing of the game part is completed for 10 cycles after the start of the first auto mode M21, the status screen 80 is displayed when the time obtained by multiplying the auto processing cycle by 10 has elapsed after the first auto mode M21 was started. In another embodiment, the display timing of the status screen 80 can be when the game part is completed for a predetermined percentage (for example, ½, ⅓, ⅕, or the like) of the maximum number of cycles. For example, the timing at which the processing of the game part is completed by ½ of the maximum number of cycles may be used as the display timing of the status screen 80. The display timing of the status screen 80 may be determined before or after the transition to the first auto mode M21.

When the end button 84 is selected on the status screen 80, the first auto mode M21 will be ended even before the elapse of the maximum running time. When the end button 84 is selected, the game part being run in the first auto mode M21 may be ended. By the selection of the end button 84, the elapsed time counted from the start of the first auto mode M21 is reset. Therefore, when the first auto mode M21 is started again, the elapsed time from the start of the first auto mode M21 is counted from the starting point of the resumed time.

Although not depicted, the status screen 80 may include a mode transition button. For example, the status screen 80 may include at least one of (i) a first transition button for transitioning to the manual mode and (ii) a second transition button for transitioning to the second auto mode M22.

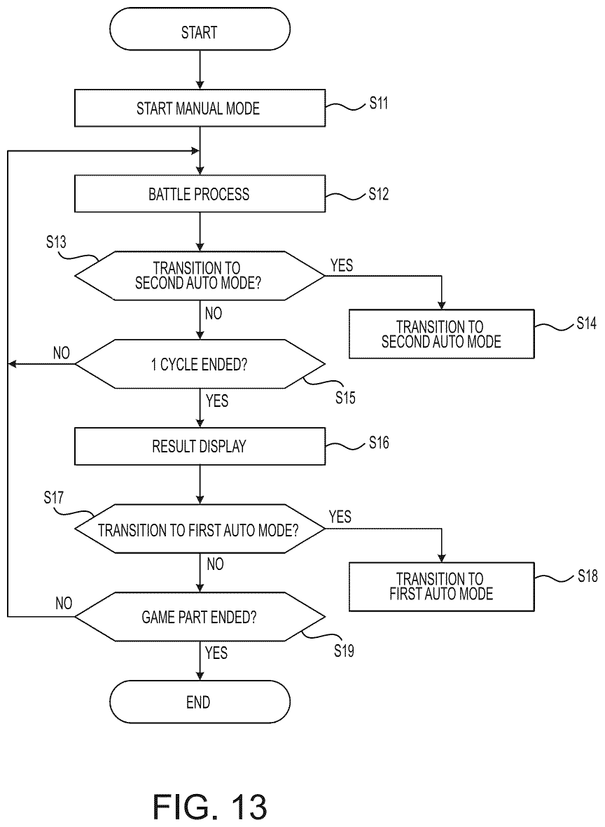

Next, referring to FIG. 13, a flow of processing for advancing the game part in the manual mode M11 will be described. In FIG. 13, it is assumed that the user has selected the battle game part.

During the running of a game, a plurality of game parts that can be selected by the user is displayed on the user device 10. The user selects one game part from among the plurality of game parts displayed on the user device 10. When a game part is selected by the user, first, in step S11, the game part starts in the manual mode M11.

Next, in step S12, the user's user character and the enemy character are engaged in a battle process. If the game part being played uses a turn-based system, attack turns are alternately generated for the user character and the enemy character. Instructions from the user are input during the user's attack turn. The user character takes actions according to the user's input. For example, the user character attacks the enemy character according to the user's input instructing the user to attack the enemy character. In an enemy character's attack turn, the user character is attacked by the enemy character.

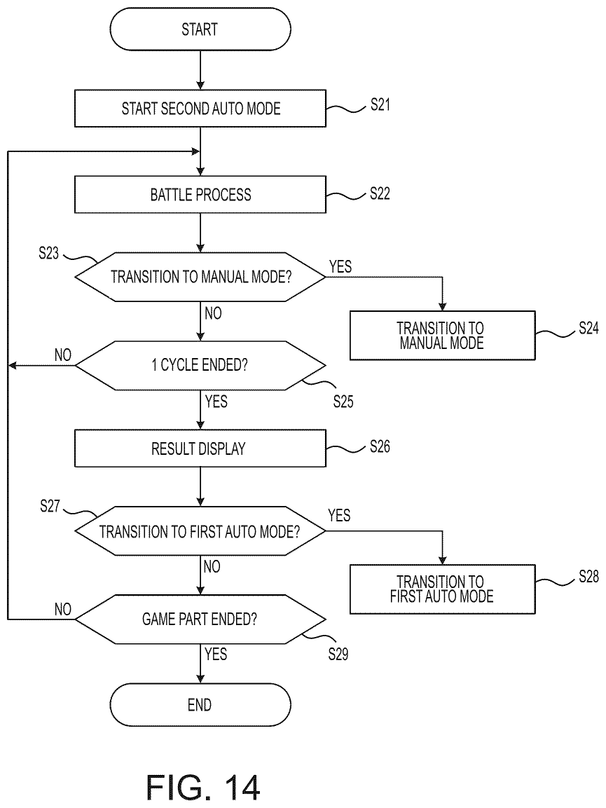

While running the game part in manual mode M11, the user device 10 displays the play screen 50, which includes a switching button 51 to switch the game mode to the second auto mode M22, as shown in FIG. 8. When the switch button 51 is selected, and the transition to the second auto mode M22 is confirmed, the transition to the second auto mode M22 is processed in step S14. After the transition process to the second auto mode M22 is completed, the game part that had been running in the manual mode M11 before the switching is run in the second auto mode M22. In the second auto mode M22, the game processing advances without any input from the user. A specific process flow in the second auto mode M22 will be described below with reference to FIG. 14.

An end condition to end one cycle of processing is set for the game part. The end condition of one cycle of the battle game part is that, for example, the user is determined to have won or lost to the enemy character. As described above, the user character's attack turn and the enemy character's attack turn are alternately performed, and when the life of the enemy character becomes zero, it may be determined that the user has won, and when the life of the user character becomes zero, it may be determined that the user is defeated. In step S15, the battle process of step S12 is repeatedly run until it is determined that the condition for ending one cycle of the game part is satisfied. When it is determined in step S15 that the end condition is satisfied, in step S16, the result screen 70 showing the play result of the completed one cycle is displayed on the user device 10.

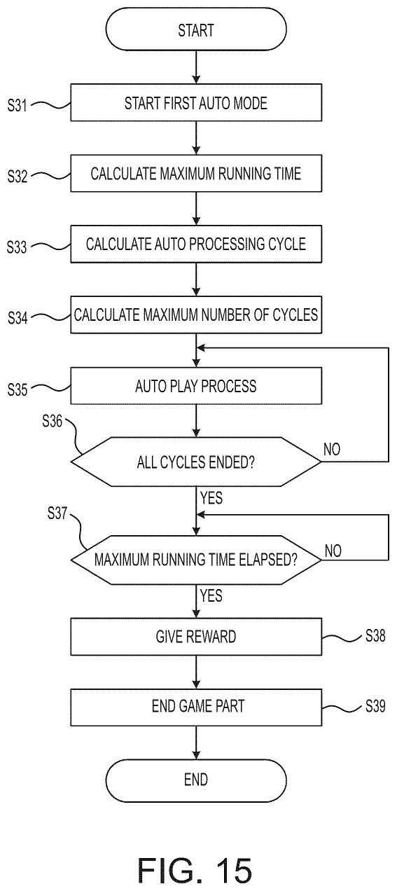

When the transition selection button 73 included in the result screen 70 is selected, and the replay button 74 is selected while the transition selection button 73 is in the selected state, in step S18, the game part being run changes from the manual mode M11 to the first auto mode M21. Also when the replay waiting time elapses while the transition selection button 73 is in the selected state, the transition to the first auto mode M21 is performed. A flow of specific processing in the first auto mode M21 will be described below with reference to FIG. 15.

When the transition to the first auto mode M21 is not performed, and when selection of the end instruction button 72 included in the result screen 70 is detected in step S19, the game part being running is ended. After the game part is ended, the main screen of the game may be displayed, or another game part may be displayed.

When the replay button 74 is selected while the transition selection button 73 included in the result screen 70 is in the non-selected state, the process returns to step S12, and the battle processing for the next cycle is started. This battle process is performed in the manual mode M11. Even when the replay waiting time has elapsed while the transition selection button 73 is in the non-selected state, the battle process for the next cycle is started in the manual mode M11.

As described above, processing of the game part in manual mode M11 continues until completion of the game part is selected in step S19. If the transition to the second auto mode M22 is selected in step S13 while the game part is being run in the manual mode M11, the game part is thereafter run in the second auto mode M22. Additionally, if the transition to the first auto mode M21 is selected in step S17 while the game part is being run in the manual mode M11, the game part is run in the first auto mode M21 thereafter.

Next, referring to FIG. 14, a flow of the process to advance the game part in the second auto mode M22 will be described below. In FIG. 14, it is assumed that the user has selected the battle game part.

First, in step S21, running of the game part is started in the second auto mode M22. The processing of the game part in the second auto mode M22 may be started in response to selection of the switching button 51 during running of the game part in the manual mode M11. Some game parts may be set to be run in the second auto mode M22.

Next, in step S22, a battle process between the user's user character and the enemy character is performed. The battle process in step S22 advances according to predetermined battle logic without input from the user.

While the game part is being run in the second auto mode M22, the user device 10 displays the play screen 50 including the switching button 51 for switching the game mode to the manual mode M11. In the second auto mode M22, the switching button 51 contains an indication “AUTO ON.” When the switching button 51 is selected and the transition to manual mode M11 is confirmed, the process of the transition to the manual mode M11 is run in step S24. After the process of the transition to the manual mode M11 is completed, the game part that had been run in the second auto mode M22 before the switching is run in the manual mode M11.

The battle process of step S22 continues until it is determined in step S25 that the end condition for one cycle of the game part is satisfied. When it is determined in step S25 that the end condition is satisfied, in step S26, the result screen 70 showing the play result of the completed cycle is displayed on the user device 10.

When the transition selection button 73 included in the result screen 70 is selected, and the replay button 74 is selected while the transition selection button 73 is in the selected state, in step S28, the game part being run is changed from the second auto mode M22 to the first auto mode M21. Also when the replay waiting time elapses while the transition selection button 73 is in the selected state, the transition to the first auto mode M21 is performed.

If the transition to the first auto mode M21 is not performed and it is detected in step S29 that the end instruction button 72 included in the result screen 70 has been selected, the game part being run is ended. After the game part is ended, the main screen of the game may be displayed, or another game part may be displayed.

If the replay button 74 is selected while the transition selection button 73 included in the result screen 70 is in a non-selected state, the process returns to step S22, and the battle process of the next cycle is started. This battle process is run in the second auto mode M22. Even when the replay waiting time has elapsed while the transition selection button 73 is in the non-selected state, the battle process for the next cycle is started in the second auto mode M22.

As described above, the processing of the game part in the second auto mode M22 continues until the end of the game part is selected in step S29. If the transition to the manual mode M11 is selected in step S23 while the game part is being run in the second auto mode M22, the game part is thereafter run in the manual mode M11. Also, if the transition to the first auto mode M21 is selected in step S27 while the game part is being run in the second auto mode M22, the game part is thereafter run in the first auto mode M21.

Next, referring to FIG. 15, a flow of processing for advancing the game part in the first auto mode M21 will be explained. In FIG. 15, it is assumed that the user has selected the battle game part.

First, in step S31, running of the game part is started in the first auto mode M21. The processing of the game part in the first auto mode M21 may be started in response to the selection of the transition to the first auto mode M21 on the result screen 70 that is displayed after processing of one cycle of the game part is completed in the manual mode M11 or the second auto mode M22.

Next, in step S32, a maximum running time, which is the upper limit of the time during which the first auto mode M21 can be continued, is calculated. The maximum running time when a user plays the game part in the first auto mode M21 may be determined based on a user parameter of the user, such as rank.

Next, in step S33, an auto processing cycle showing the time required to process one cycle of the game part in the first auto mode M21 is calculated. The auto processing cycle is calculated by adding an interval (for example, 20 seconds) between cycles to the clear time spent to clear one cycle of the game part immediately before the transition to the first auto mode M21.

Next, in step S34, the maximum number of cycles is calculated which shows how many cycles of the game part can be executed from the start of the first auto mode M21 until the maximum running time elapses. The maximum number of cycles is calculated based on the maximum running time and the auto processing cycle. The quotient obtained by dividing the maximum running time by the auto processing cycle can be used as the maximum number of cycles. For example, if the maximum running time is 8 hours and the auto processing cycle is 2 minutes and 47 seconds, 172 cycles are taken as the maximum number of cycles.

Next, in step S35, a battle process between the user character and the enemy character is run without input from the user. For example, in step S35, victory or defeat is determined probabilistically based on, in each auto processing cycle, (i) the parameters (attack power, defense power, life, and the like) showing the ability of the user character that is in the battle and (ii) the parameters (attack power, defense power, life, and the like) showing the ability of the enemy character. Through this determination of victory or defeat, the processing for one cycle of the game part in the first auto mode M21 ends. If the auto processing cycle is 2 minutes and 47 seconds, one cycle of processing is performed every 2 minutes and 47 seconds.

Next, in step S36, it is determined whether the total number of cycles processed in step S35 from the start of the first auto mode M21 has reached the maximum number of cycles. In the above-described example, 172 cycles is the maximum number of cycles, so it is determined whether the total number of cycles processed in step S35 has reached 172 cycles. If the cumulative number of processed cycles is smaller than the maximum number of cycles, the battle processing in units of cycles is continued in step S35. If the total number of processed cycles has reached the maximum number of cycles, then in step S37 it is determined whether the elapsed time from the start of the first auto mode M21 has reached the maximum running time.

All of the above processing of the first auto mode M21 in steps S32 to S37 may be performed in the server 20 (for example, the auto processor 21c).

When the elapsed time from the start of the first auto mode M21 has reached the maximum running time, the first auto mode M21 is ended in step S38, and the reward to be given to the user is determined. The process of determining the reward to be given to the user may be performed as part of the first auto mode M21, or may be performed as a separate process from the first auto mode M21 after the first auto mode M21 ends. In an aspect, the reward is determined, for example, based on the number of times the user is determined to have won from the start to the end of the first auto mode M21. In this case, the more times the user is determined to have won, the greater the reward that may be given to the user. In another aspect, the reward may be determined based on (i) the number of times the user is determined to have won from the start to the end of the first auto mode M21 and (ii) the maximum number of cycles. The reward determination may be made such that the higher the maximum number of cycles, the higher the reward. The reward determined in step S38 is given to the user. The reward given to the user may be determined based on a probability table. In a probability table in an embodiment, a selection probability of a game medium (for example, a game item) that may be given as a reward may be established for each number of victories of the user or each number of cycles (number of completed cycles) run in the first auto mode M21. In the probability table, the selection probability may be set such that the greater the number of victories or the number of completed cycles by the user, the easier it is for the game medium to be selected. In another embodiment, a single probability table is established, and a lottery process based on the probability table may be performed for the number of victories or the number of completed cycles. For example, if the number of victories is 20 times, a lottery process based on the probability table is performed 20 times, and game media won in the 20 lottery processes are given to the user as a reward.

When the first auto mode M21 ends, an end notification may be displayed on the user device 10 to notify the user of the end of the first auto mode M21. Since the first auto mode M21 is run even while the game application 15a is running in the background or while the game application 15a is not activated, at the end of the first auto mode M21, the game application 15a may not be running in the foreground. By displaying the end notice on the user device 10, the user can be notified in a timely manner that the first auto mode M21 has ended.

Next, the game part is ended in step S39. As described above, the process of game part in the first auto mode M21 is performed.

Next, some of the effects of operation realized by the above embodiment will be described.

In an embodiment, in the first auto mode M21, the game part is repeatedly run within a maximum running time without input from the user, so the user can earn the reward given at the end of the game part with little effort. Additionally, since the time during which the first auto mode M21 can be continuously performed is limited to be within a maximum running time, the consumption of computing resources for running the game part in the first auto mode M21 can be suppressed.

In one embodiment, the larger the maximum number of cycles, the greater the opportunity for the user to earn rewards. Although the running time of the first auto mode M21 is limited to be within the maximum running time, the user can shorten the auto processing cycle by clearing the game part immediately before transitioning to the first auto mode M21 in a short time, and as a result, the maximum number of cycles can be increased. Thus, the user can increase the opportunity to earn rewards by clearing the game part immediately before transitioning to the first auto mode M21 in a short time.

In an embodiment, the result screen 70 is displayed on the user device 10 in response to the end of the game part in the manual mode M11 or the second auto mode M22. The result screen 70 includes (i) a clear time display area 71 showing a first play time spent in clearing the game part that was cleared immediately before the result screen 70 is displayed, and (ii) a transition selection button 73 for selecting the transition to the first auto mode M21. This allows the first play time, which affects the efficiency of earning rewards in the first auto mode M21, to be presented to the user when the user selects whether or not to transition to the first auto mode M21. If the first play time is long, the user can run the game part again in the manual mode M11 or the second auto mode M22 to clear the game in a shorter time.

In an embodiment, according to the user's selection, the second auto mode M22 is run in limited or non-limited mode. Thus, the user can be involved in the progress of the game in the second auto mode M22 through the selection of the limited or non-limited mode, without performing any input during the running of the game part in the second auto mode M22. Thus, the game part run in the second auto mode M22 can advance and be cleared without requiring input from the user, but by accepting the selection of the limited or non-limited mode from the user, it is possible to provide the user with a richer playing experience while reducing the user's input effort.

In an embodiment, in the second auto mode M22, whether or not a skill can be used may be set for each user character or for each skill, based on an instruction from the user. This provides an even richer playing experience than the selection between limited and non-limited modes.

In an embodiment, in the first auto mode M21, the game part is run even while the game application 15a is being run in the background on the user device 10. As a result, even while an application other than the game application 15a is running in the foreground on the user device 10, the game part can be run in the first auto mode M21. Therefore, it is possible to earn a game reward while the user is using an application other than the game application 15a on the user device 10.

In an embodiment, in the first auto mode M21, the game part is run even while the game application 15a is not being run on the user device 10. Thereby, it is possible to obtain a game reward without using the computing resources of the user device 10.

In an embodiment, during running of the game part in the first auto mode M21, the user device 10 can display a status screen showing the status of the first auto mode M21. As a result, the progress of the game part in the first auto mode M21 can be confirmed without interrupting the processing of the game part in the first auto mode M21. On the status screen 80, the user can check the progress (for example, the number of victories and the number of completed cycles calculated at the time the status screen 80 is displayed) and remaining time of the first auto mode M21. For example, based on the remaining time displayed on the status screen 80, the user can determine whether to end the first auto mode M21 or continue to run the first auto mode M21 up to the maximum running time. Additionally, based on the remaining time displayed on the status screen 80, the user can determine whether to return the game application 15a to the foreground.

The game system 1 shown in FIG. 1 is an example of a system to which these embodiments can be applied, and the game system to which this invention can be applied is not limited to what is shown in FIG. 1. The game system 1 to which these embodiments can be applied may not be provided with some of the components illustrated. For example, the game system 1 does not need to include the storage 30. The game system 1 may include structural elements that are not depicted. Although only one user device 10 is shown in FIG. 1 to simplify the explanation, the game system 1 can include any number of user devices 10 equal to or greater than two. The game system 1 may include a cloud environment for distributing and processing the process to be run by the user device 10 or the server 20.

In the game system 1, there is no particular restriction on where data may be stored. For example, various data that may be stored in the storage 15 may be stored in a storage (for example, storage 30) or database server that is physically separate from the storage 15. Data described in this specification as being stored in the storage 15 may be stored in a single storage or distributed and stored across a plurality of storages. Also, in this specification and within the scope of the claims, simply “storage” may refer to either a single storage or a set of a plurality of storages, as the context permits. The above description of data that may be stored in the storage 15 applies also to data stored in the storage 25 as much as possible.

The embodiments are not limited to the embodiments described above, and various changes are possible within a scope that does not depart from the substance thereof. For example, some or all of the functions performed by the processor 11 and the processor 21 may be realized by a processor(s) not specified in this specification to an extent not departing from the intent of the disclosure. In FIG. 1, the processor 11 is depicted as a single structural element, but the processor 11 may be a set of multiple physically separate processors. The same is true for the processor 21. The program described in this specification as being run by the processor 11 and the processor 21, or commands included in the program, may be run by a single processor or distributed and run by a plurality of processors. Also, the program or commands included in the program described as being run by the processor 11 and the processor 21 may also be run by one or more virtual processors.

The program run by the processor 11 and/or the processor 21 can be stored on various types of non-transitory computer readable media other than the depicted storages. Non-transitory computer readable media include various types of tangible storage media. Examples of non-transitory computer readable media include magnetic recording media (for example, a flexible disk, a magnetic tape, a hard disk drive), magneto-optical recording media (for example, a magneto-optical disk), Compact Disc Read Only Memory (CD-ROM), CD-R, CD-R/W, semiconductor memory (for example, mask ROM, Programmable ROM (PROM), Erasable PROM (EPROM), flash ROM, and Random Access Memory (RAM).

Even though processes and procedures described in this specification are described as being performed by a single device, software, component, or module, such processes or procedures may be performed by multiple devices, multiple software, multiple components, and/or multiple modules. Also, even though the data, tables, or databases described in this specification are described as being stored in a single memory, such data, tables, or databases can be distributed and stored in multiple memories provided in a single device, or distributed and stored in multiple memories located in multiple devices. Additionally, the software and hardware elements described in this specification may be realized by integrating them into fewer components or by breaking them into a larger number of components.

In the processing procedures described in this specification, especially those described using flow diagrams or sequence diagrams, it is possible to omit some of the processes (steps) that constitute the processing procedure, to add processes that are not explicitly indicated as processes constituting the processing procedure, and/or to change the order of such processes. Such omitted, added, or reordered processing procedures are included in the scope of this disclosure as long as they do not depart from the intent of the disclosure.

Notations such as “first,” “second,” “third,” and the like in this specification and the scope of the claims are added to identify structural elements and do not necessarily limit the number, order, or content of the components. Additionally, the numbers used to identify structural elements are used on a context-by-context basis, and the number used in one context is not necessarily limited to the same configuration in another context. Nor does it preclude a structural element identified by one number from serving the function of a structural element identified by another number.

The following technical items are also disclosed in this specification.

### [Supplemental Note 1]

A game system comprising:
a storage that stores a user parameter related to a user of a game in association with user identification information that identifies the user, and
one or more processors, wherein:
the one or more processors:
   count an elapsed time since the first auto mode was started, and
   in the first auto mode, run a game part of the game without input from the user until the elapsed time from a start of the first auto mode reaches a maximum running time that is determined based on the user parameter.

### [Supplemental Note 2]

The game system according to supplemental note 1, wherein the one or more processors:
advance the game part based on input from the user in a manual mode,
based on a first play time spent to advance the game part for one cycle in the manual mode, determine a first processing cycle required to run the game part for one cycle in the first auto mode, and
in the first auto mode, run the game part for a maximum number of cycles that is determined based on the maximum running time and the first processing cycle.

### [Supplemental Note 3]

The game system according to supplemental note 2, wherein:
the one or more processors cause a user device of the user to display (i) the first play time and (ii) a mode switching button that selects a transition to the first auto mode in response to completion of the game part in the manual mode.

### [Supplemental Note 4]

The game system according to any of supplemental notes 1-3, wherein:
the one or more processors start the game part without requiring a consumption of points that increase along with the passage of time.

### [Supplemental Note 5]

The game system according to any of supplemental notes 1-4, wherein:
in the first auto mode, the one or more processors run the game part even while an application for the game is being run in the background.

### [Supplemental Note 6]

The game system according to any of supplemental notes 1-5, wherein:
in the first auto mode, the one or more processors run the game part even while an application for the game is not being run.

### [Supplemental Note 7]

The game system according to any of supplemental notes 1-6, wherein:
the one or more processors cause a user device of the user to display status information showing a status of the first auto mode during running of the game part in the first auto mode.

### [Supplemental Note 8]

The game system according to supplemental note 7, wherein:
the status information includes (i) the maximum running time and an elapsed time since the first auto mode was started, or (ii) a remaining time obtained by subtracting the elapsed time from the maximum running time.

### [Supplemental Note 9]

The game system according to supplemental note 2, wherein:
the one or more processors cause a user device of the user to display status information showing a status of the first auto mode during running of the game part in the first auto mode, and
the status information includes a number of completed cycles that is determined based on (i) an elapsed time from the start of the first auto mode and (ii) the first processing cycle.

### [Supplemental Note 10]

The game system according to supplemental note 9, wherein:
the one or more processors calculate the number of completed cycles according to an application for the game being activated on the user device of the user after a first time period, which is shorter than the maximum running time, has elapsed since the start of the first auto mode.

### [Supplemental Note 11]

The game system according to claim 9, wherein:
in the first auto mode, the one or more processors calculate the number of completed cycles according to a transition of an application for the game from a background to a foreground.

### [Supplemental Note 12]

The game system according to any of supplemental notes 1-8, wherein:
in a second auto mode, the one or more processors cause the game part to advance without input from the user only when an application for the game is running in a foreground.

### [Supplemental Note 13]

The game system according to supplemental notes 1-12, wherein the one or more processors:
determine a second processing cycle required to run the game part for one cycle in the first auto mode based on a second play time spent to advance the game part for one cycle in the second auto mode, and
in the first auto mode, run the game part for a number of second cycles that is determined based on the maximum running time and the second processing cycle.

### [Supplemental Note 14]

The game system according to supplemental note 13, wherein:
in response to completion of the game part in the second auto mode, the one or more processors cause a user device of the user to display the second play time and a mode switching button to switch to the first auto mode.

### [Supplemental Note 15]

The game system according to any of supplemental notes 1-4, wherein:
the second auto mode includes (i) a limited mode in which a limited game function among a plurality of game functions is not used and (ii) a non-limited mode in which the limited game function is useable; and
the one or more processors advance the game part in either the limited mode or the non-limited mode according to a selection by the user.

### [Supplemental Note 16]

The game system according to any of supplemental notes 1-15, wherein:
in the game part, a character is used that can use a plurality of game functions, and for each of the plurality of game functions, it is possible to set whether or not the function can be used in the second auto mode.

### [Supplemental Note 17]

A game processing method that processes a game by one or more processors executing a computer-readable command, the game processing method comprising the following steps:
storing a user parameter related to a user of the game in association with user identification information identifying the user;
counting an elapsed time since a first auto mode was started; and
in the first auto mode, running a game part of the game without input from the user until the elapsed time from the start of the first auto mode reaches a maximum running time that is determined based on the user parameter.

### [Supplemental Note 18]

A game program that causes one or more processors to perform the following steps:
storing a user parameter related to a user of a game in association with user identification information identifying the user;
counting an elapsed time since a first auto mode was started; and
in the first auto mode, running a game part of the game without input from the user until the elapsed time from the start of the first auto mode reaches a maximum running time that is determined based on the user parameter.

### ADDITIONAL SUPPLEMENTAL NOTES

A game system comprising:
one or more processors, wherein:
the one or more processors
in a first auto mode, run a game part of a game without input from a user until an elapsed time from a start of the first auto mode reaches a maximum running time;
in a manual mode, advance the game part based on input from the user;
based on a first play time spent to advance the game part for one cycle in the manual mode, determine a first processing cycle required to run the game part for one cycle in the first auto mode; and
in the first auto mode, run the game part for a maximum number of cycles that is determined based on the maximum running time and the first processing cycle.

A game system, comprising:
one or more processors, wherein:
the one or more processors
in a first auto mode, run a game part of a game without input from a user until an elapsed time from a start of the first auto mode reaches a maximum running time; and
in the first auto mode, run the game part even while an application for the game is not being run.

The game system according to claim 1, wherein:
in response to completion of the game part in the manual mode, the one or more processors cause a user device of the user to display (i) the first play time and (ii) a mode switching button that selects a transition to the first auto mode.

The game system according to claim 1 or 2, wherein:
the one or more processors start the game part without requiring a consumption of points that increase along with the passage of time.

The game system according to claim 1, wherein:
in the first auto mode, the one or more processors run the game part even while an application for the game is being run in a background.

The game system according to claim 1 or 2, wherein:
the one or more processors cause a user device of the user to display status information showing a status of the first auto mode during running of the game part in the first auto mode.

The game system according to claim 6, wherein:
the status information includes (i) the maximum running time and an elapsed time since the first auto mode was started, or (ii) a remaining time obtained by subtracting the elapsed time from the maximum running time.

The game system according to claim 1, wherein:
the one or more processors cause a user device of the user to display status information showing a status of the first auto mode during running of the game part in the first auto mode, and
the status information includes a number of completed cycles that is determined based on (i) an elapsed time from the start of the first auto mode and (ii) the first processing cycle.

The game system according to claim 8, wherein:
the one or more processors calculate the number of completed cycles in response to an application for the game being activated on the user device of the user after a first time period, which is shorter than the maximum running time, has elapsed from the start of the first auto mode.

The game system according to claim 8, wherein:
in the first auto mode, the one or more processors calculate the number of completed cycles in response to a transition of an application for the game from a background to a foreground.

The game system according to claim 1 or 2, wherein:
in a second auto mode, the one or more processors advance the game part without input from the user only when an application for the game is running in a foreground.

The game system according to claim 11, wherein the one or more processors:
determine a second processing cycle required to run the game part for one cycle in the first auto mode based on a second play time spent to advance the game part for one cycle in the second auto mode, and
in the first auto mode, run the game part for a second number of cycles that is determined based on the maximum running time and the second processing cycle.

The game system according to claim 12, wherein:
in response to completion of the game part in the second auto mode, the one or more processors cause a user device of the user to display the second play time and a mode switching button to switch to the first auto mode.

The game system according to claim 11, wherein:
the second auto mode includes (i) a limited mode in which a limited game function among a plurality of game functions is not used and (ii) a non-limited mode in which the limited game function is usable; and
the one or more processors advance the game part in either the limited mode or the non-limited mode according to a selection by the user.

The game system according to claim 11, wherein:
in the game part, a character is used that can use a plurality of game functions, and for each of the plurality of game functions, it is possible to set whether or not that function can be used in the second auto mode.

A game processing method that processes a game by one or more processors executing a computer-readable command to perform the following steps:
in a first auto mode, running a game part of a game without input from a user until an elapsed time from a start of the first auto mode reaches a maximum running time;
in a manual mode, advancing the game part based on input from the user;
based on a first play time spent to advance the game part for one cycle in the manual mode, determining a first processing cycle required to run the game part for one cycle in the first auto mode; and
in the first auto mode, running the game part for a maximum number of cycles that is determined based on the maximum running time and the first processing cycle.

A game program that causes one or more processors to execute the following steps:
in a first auto mode, running a game part of a game without input from a user until an elapsed time from a start of the first auto mode reaches a maximum running time;
in a manual mode, advancing the game part based on input from the user;
based on a first play time spent to advance the game part for one cycle in the manual mode, determining a first processing cycle required to run the game part for one cycle in the first auto mode; and
in the first auto mode, running the game part for a maximum number of cycles that is determined based on the maximum running time and the first processing cycle.

A game processing method that processes a game by one or more processors executing a computer-readable command to perform the following steps:
in a first auto mode, running a game part of a game without input from a user until an elapsed time from a start of the first auto mode reaches a maximum running time; and
in the first auto mode, running the game part even while an application for the game is not being run.

A game program that causes one or more processors to execute the following steps:
in a first auto mode, running a game part of a game without input from a user until an elapsed time from a start of the first auto mode reaches a maximum running time; and
in the first auto mode, running the game part even while an application for the game is not being run.

### EXPLANATION OF SYMBOLS

1 Game system
10 User device
11 Processor
11a Game progress portion
11b Game part processor
11c Mode switching portion
15 Storage
15a Game application
20 Server
21 Processor
21a Game controller
21b Mode setting portion
21c Auto processor
25 Storage
25a User management data
25b Game media management data
25c Mode management data
25d Status data

1. A game system comprising:
a memory that stores a user parameter related to a user of a game in association with user identification information that identifies the user; and
one or more processors programmed to:
count an elapsed time since a first auto mode was started, and
in the first auto mode, run a game part of the game without input from the user until the elapsed time reaches a maximum running time that is determined based on the user parameter.

2. The game system according to claim 1, wherein
the one or more processors are further programmed to:
advance the game part based on input from the user in a manual mode,
based on a first play time spent to advance the game part for one cycle in the manual mode, determine a first processing cycle required to run the game part for one cycle in the first auto mode, and
in the first auto mode, run the game part for a maximum number of cycles that is determined based on the maximum running time and the first processing cycle.

3. The game system according to claim 2, wherein
the one or more processors cause a user device of the user to display (i) the first play time and (ii) a mode switching button that selects a transition to the first auto mode in response to completion of the game part in the manual mode.

4. The game system according to claim 1, wherein
the one or more processors start the game part without requiring a consumption of points that increase along with the passage of time.

5. The game system according to claim 1, wherein
in the first auto mode, the one or more processors run the game part while an application for the game is being run in the background.

6. The game system according to claim 1, wherein
in the first auto mode, the one or more processors run the game part while an application for the game is not being run.

7. The game system according to claim 1, wherein
the one or more processors cause a user device of the user to display status information showing a status of the first auto mode during running of the game part in the first auto mode.

8. The game system according to claim 7, wherein
the status information includes (i) the maximum running time and the elapsed time since the first auto mode was started, or (ii) a remaining time obtained by subtracting the elapsed time from the maximum running time.

9. The game system according to claim 2, wherein
the one or more processors cause a user device of the user to display status information showing a status of the first auto mode during running of the game part in the first auto mode, and
the status information includes a number of completed cycles that is determined based on (i) the elapsed time since the first auto mode was started and (ii) the first processing cycle.

10. The game system according to claim 9, wherein
the one or more processors calculate the number of completed cycles according to an application for the game being activated on the user device of the user after a first time period, which is shorter than the maximum running time, has elapsed since the first auto mode was started.

11. The game system according to claim 9, wherein
in the first auto mode, the one or more processors calculate the number of completed cycles upon a transition of an application for the game from a background to a foreground.

12. The game system according to claim 1, wherein
in a second auto mode, the one or more processors cause the game part to advance without input from the user only when an application for the game is running in a foreground.

13. The game system according to claim 12, wherein
the one or more processors are further programmed to:
determine a second processing cycle required to run the game part for one cycle in the first auto mode based on a second play time spent to advance the game part for one cycle in the second auto mode, and
in the first auto mode, run the game part for a number of second cycles that is determined based on the maximum running time and the second processing cycle.

14. The game system according to claim 13, wherein
in response to completion of the game part in the second auto mode, the one or more processors cause a user device of the user to display the second play time and a mode switching button to switch to the first auto mode.

15. The game system according to claim 12, wherein
the second auto mode includes (i) a limited mode in which a limited game function among a plurality of game functions is not used and (ii) a non-limited mode in which the limited game function is usable, and
the one or more processors advance the game part in either the limited mode or the non-limited mode according to a selection by the user.

16. The game system according to claim 12, wherein
in the game part, a character uses a plurality of game functions, and
for each of the plurality of game functions, the one or more processors set whether or not the respective game function is usable in the second auto mode.

17. A game processing method that processes a game by one or more processors executing a computer-readable command, the game processing method comprising the following steps:
storing in a memory a user parameter related to a user of the game in association with user identification information identifying the user;
counting an elapsed time since a first auto mode was started; and
in the first auto mode, running a game part of the game without input from the user until the elapsed time reaches a maximum running time that is determined based on the user parameter.

18. A non-transitory computer-readable medium storing thereon a game program that causes one or more processors to perform the following steps:
storing in a memory a user parameter related to a user of a game in association with user identification information identifying the user;
counting an elapsed time since a first auto mode was started; and
in the first auto mode, running a game part of the game without input from the user until the elapsed time reaches a maximum running time that is determined based on the user parameter.
